(19) United States
(12) Patent Application Publication
(10) Pub. No.: US 2026/0194776 A1
(43) Pub. Date: Jul. 9, 2026

(54) COMPOSITION

(71) Applicant: SAMSUNG ELECTRONICS CO., LTD., Suwon-si, Gyeonggi-do (KR)

(72) Inventors: Nils GREINERT, Darmstadt (DE); Meike KRUMWIEDE, Darmstadt (DE)

(73) Assignee: SAMSUNG ELECTRONICS CO., LTD., Suwon-si, Gyeonggi-do (KR)

(21) Appl. No.: 19/128,197

(22) PCT Filed: Nov. 7, 2023
(86) PCT No.: PCT/EP2023/081019

§ 371 Date: May 8, 2025

(30) Foreign Application Priority Data
Nov. 10, 2022 (EP) 222065713.4

(51) Int. Cl. G02F 1/1335; C09K 11/06

(52) U.S. Cl. CPC G02F 1/133514; C09K 11/06; C09K 2211/14; G02F 2202/02

(57) ABSTRACT

The present invention relates to a composition comprising at least one light emitting moiety.

### FIELD OF THE INVENTION

The present invention relates to a composition, preferably being of a photocurable composition, comprising at least one light emitting moiety; process for fabricating a composition, a composite, process for fabricating a composite, use, a color conversion device, an optical device containing at least one-color conversion device, method for fabricating a color conversion device.

### BACKGROUND ART

WO 2017/054898 A1 describes a composition comprising red emission type nanocrystals, wetting and dispersing agent, propylene glycol monomethyl ether acetate as a solvent, an acryl polymer mixture including an acrylic unit including an acid group and a silane modified acrylic unit.

WO 2019/002239 A1 discloses a composition comprising a semiconducting light emitting nanoparticles, a polymer and a (meth)acrylate such as 1.4. cyclohexanedimethanol-monoacrylate having high viscosity around 90 cp.

### PATENT LITERATURE

1. WO 2017/054898 A1
2. WO 2019/002239 A1

### SUMMARY OF THE INVENTION

However, the inventors newly have found that there are still one or more of considerable problems for which improvement is desired, as listed below: realizing an optimized haze value of the cured layer (film), optimal haze value with improved EQE value of the cured layer (film), preferably obtaining optimal haze value with improved EQE value of the cured layer (film) without using scatting particle, improved thermal stability of an obtained layer (film), improved thermal stability of a light emitting moiety in a layer (film), improved dispersibility of a light emitting moiety in a composition, enabling a phase separation of light emitting moiety and matrix material after curing realizing an improved haze value of the cured film (cured composition), improved dispersibility of a light emitting moiety in an obtained layer, improved long term Quantum Yield (QY) stability of a light emitting moiety in the composition in a longer term storage with our without external light irradiation, improved long term External Quantum Efficiency (EQE) stability of a light emitting moiety in the composition in a longer term storage with our without external light irradiation, improved long term Quantum Yield (QY) stability of a light emitting moiety in the obtained layer (film) in a longer term storage with our without light external irradiation, improved long term External Quantum Efficiency (EQE) stability of a light emitting moiety in the obtained layer (film) in a longer term storage with our without external light irradiation, improved good compatibility of light emitting moiety with a matrix material in a composition and/or an obtained layer (film), and/or realizing easy handling of a composition containing a light emitting moiety and a matrix material, making composition suitable for inkjet printing.

The inventors aimed to solve one or more of the above-mentioned problems.

The present inventors have surprisingly found that one or more of the above-described technical problems can be solved by the features as defined in the claims.

Namely, it is found a novel composition, composition, preferably it is being of a photocurable composition, more preferably it is being a photocurable composition for ink-jetting, comprising at least, essentially consisting of or consisting of,
i) at least one reactive monomer or a mixture of two or more reactive monomers, preferably said monomer having one or more of functional groups, more preferably said monomer is a (meth)acrylate monomer;
ii) a light emitting moiety;
iii) a 1^{st} chemical compound represented by following chemical formula (I^{A}); and
iv) a 2^{nd} chemical compound represented by following chemical formula (I^{B}).

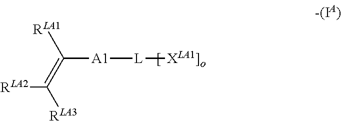

wherein
is 1, 2 or 3, preferably 1;
R^{LA1} is H, D, CN, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms may be replaced by D, F, Cl, Br, I, CN or NO₂;
R^{LA2}, R^{LA3} are, independently of each other, H, D, CN, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by —R^{a}C≡CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; or an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms may be replaced by D, F, Cl, Br, I, CN or NO₂;
R^{a} is at each occurrence, identically or differently, H, D, O, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms; a straight-chain alkenyl or alkynyl group having 2 to 40 carbon atoms, preferably 2 to 24 carbon atoms, more preferably 2 to 12 carbon atoms; a branched alkenyl group or alkynyl group having 3 to 40 carbon atoms, preferably 3 to 24 carbon atoms, more preferably 3 to 12 carbon atoms; an aromatic or heteroaromatic ring system having 5 to 40 aromatic ring atoms, preferably 5 to 25 aromatic ring atoms, more preferably 5 to 18 aromatic ring atoms, wherein in each of the above-mentioned groups one or more H atoms may be replaced by D, F, Cl, Br, I, and where two or more adjacent substituents R^{a} here may optionally form a mono- or polycyclic, aliphatic ring system with one another;
A¹ is

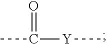

Y is O, N, S, preferably 0 or N;
L is a divalent group selected from a straight-chain alkylene group having 1 to 40 carbon atoms, preferably 3 to 24 carbon atoms, more preferably 4 to 12 carbon atoms; a branched or cyclic alkylene group having 3 to 40 carbon atoms, preferably 4 to 24 carbon atoms, more preferably 5 to 12 carbon atoms; a straight-chain alkenylene or alkynylene group having 2 to 40 carbon atoms, preferably 3 to 24 carbon atoms, more preferably 4 to 12 carbon atoms; or a branched alkenylene group or alkynylene group having 3 to 40 carbon atoms, preferably 4 to 24 carbon atoms, more preferably 5 to 12 carbon atoms, each of which each may be substituted by one or more groups R^{a}, where in each case one or more CH₂ groups may be replaced by an arylene group or heteroarylene group having 5 to 40 aromatic ring atoms, preferably 5 to 25 aromatic ring atoms, more preferably 5 to 18 aromatic ring atoms, Si(R^{a})₂, Ge(R^{a})₂, Sn(R^{a})₂, C═0, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic or heteroaromatic ring system having 5 to 40 aromatic ring atoms, preferably 5 to 25 aromatic ring atoms, more preferably 5 to 18 aromatic ring atoms, an aralkylene group, a heteroaralkylene group, an alkylarylene group or an alkylheteroarylene group, each of which may be substituted by one or more groups R^{a}, and where in each case one or more H atoms may be replaced by D, F, Cl, Br, I, CN, NO₂; or a group represented by the following chemical formula (II) or (II′);

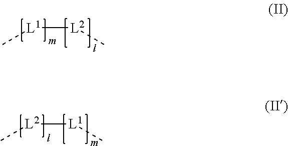

wherein
m is an integer of 1 to 50, preferably 1 to 25, more preferably 2 to 20, and furthermore preferably 4 to 12;
I is 0 or an integer of 1 to 25, preferably 0 or 1 to 20, more preferably 0 or 1 to 12, and furthermore preferably 0 or 1 to 8;
L¹ is

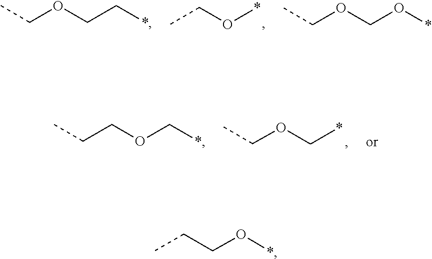

preferably

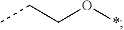

L² is

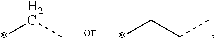

preferably

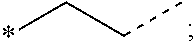

wherein a dashed line indicates a bond to the remainder of the compound and the symbol “*” marks the bond between groups L¹ and L², and wherein each of L¹ and L² may be substituted by one or more groups R^{a}, where one or more CH₂ groups of L¹ and L² may be replaced by —R^{a}C≡CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, NR^{a}, or —C(═O)NR^{a}—, and where one or more H atoms in L¹ and L² may be replaced by D, F, Cl, Br, I, CN or NO₂;
X^{LA1} is, identically or differently on each occurrence, an anchor group preferably selected from —COOM¹, —CO-A³-COOM¹, —OCO-A³-COOM¹, —NCO-A³-COOM¹, —PO(OH)(OM¹), —PO(OM¹)₂, —OC(S)SM¹, —NH₂, —NHR^{a}, —N(R^{a})₂, —SO₃M¹, -SM¹, —Ar¹—SM¹, —OCO-A³-SM¹, —COO-A³-SM¹, —NCO-A³-SM¹, SiOR^{a}, or —N(CS₂M¹)₂;
Ar¹ is a divalent group selected from an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms of the aromatic or heteroaromatic ring system may be replaced by D, F, Cl, Br, I, CN, NO₂;
A³ is a divalent group selected from a straight-chain alkylene group having 1 to 40 carbon atoms, preferably 1 to 25 carbon atoms, more preferably 1 to 15 carbon atoms; a branched or cyclic alkylene group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic or heteroaromatic ring system having 5 to 25 aromatic ring atoms, preferably 5 to 18 aromatic ring atoms, more preferably 5 to 12 aromatic ring atoms, each of which may be substituted by one or more groups R^{a}, and where one or more H atoms of the aromatic or heteroaromatic ring system may be replaced by D, F, Cl, Br, I, CN, NO₂;
M¹ denotes a hydrogen atom, or a metal cation selected from ½Mg²⁺, ½ Cu²⁺, ½ Zn²⁺, ½ Pb²⁺, ½ Sn²⁺, ½ Cd²⁺, ⅓ Bi³⁺ or ¼ Sn⁴⁺, preferably a hydrogen atom, ½ Mg²⁺, ½ Cu²⁺, or ½ Zn²⁺, more preferably a hydrogen atom;

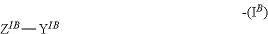

wherein
Z^{IB} is *—R^{x1} or

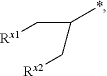

where “*” represents the connecting point to symbol Y of the formula;
R^{x1} is a group selected from one or more members of the group consisting of phosphine group, phosphine oxide group, phosphate group, phosphonate group, thiol group, tertiary amine, carboxyl group, hetero cyclic group, silane group, sulfonic acid, hydroxyl group, phosphonic acid, preferably said group is a phosphonate group, thiol group, a carboxyl group or a combination of any of these, more preferably it is a carboxyl group; and
R^{x2} is a group selected from one or more of members of the group consisting of phosphine group, phosphine oxide group, phosphate group, phosphonate group, thiol group, tertiary amine, carboxyl group, hetero cyclic group, silane group, sulfonic acid, hydroxyl group, phosphonic acid, preferably said group is a phosphonate group, thiol group, a carboxyl group or a combination of any of these, more preferably it is a carboxyl group;
Y^{IB} is a straight-chain alkyl group having carbon atoms 1 to 45 or branched alkyl group having carbon atoms 3 to 45, straight-chain alkenyl group having carbon atoms 1 to 45 or branched alkenyl group having carbon atoms 3 to 45, straight-chain alkoxyl group having carbon atoms 1 to 45 or branched alkoxyl group having carbon atoms 3 to 45, preferably said carbon atoms of the alkyl group, the alkenyl group and/or the alkoxy group are in the range from 10 to 35, more preferably it is from 14 to 30, even more preferably from 16 to 28, furthermore preferably it is from 19 to 26, preferably said alkyl group, alkenyl group and/or alkoxy group may be substituted or unsubstituted, more preferably said alkyl group, alkenyl group and/or alkoxy group, may be substituted by one or more radicals R^{a}, where one or more non-adjacent CH₂ groups may be replaced by R^{a}C═CR^{a}, C≡C, Si(R^{a})₂, Ge(R^{a})₂, Sn(R^{a})₂, C═O, C═S, C═Se, C═NR^{a}, P(═O)(R^{a}), SO, SO₂, NR^{a}, OS, or CONR^{a} and where one or more H atoms may be replaced by D, F, Cl, Br, I, CN or NO₂, preferably Y is a straight-chain or branched alkyl group,
R^{a} is at each occurrence, identically or differently, H, D or an alkyl group having 1 to 20 carbon atoms, cyclic alkyl or alkoxy group having 3 to 40 carbon atoms, an aromatic ring system having 5 to 60 carbon ring atoms, or a hetero aromatic ring system having 5 to 60 carbon atoms, wherein H atoms may be replaced by D, F, Cl, Br, I; two or more adjacent substituents R^{a} here may also form a mono- or polycyclic, aliphatic, aromatic or heteroaromatic ring system with one another,
wherein Y^{IB} contains at least one carbon-carbon double bond, preferably said chain contains 1 to 5 carbon-carbon double bonds, more preferably 1 to 3 carbon-carbon double bonds, even more preferably 1 to 2 carbon-carbon double bonds in the chain.

In another aspect, the present invention relates to a process for fabricating the composition of the present invention comprising at least, essentially consisting of or consisting of, the following step Y1;
Y1) mixing at least one light emitting moiety, a reactive monomer, the chemical compound to form the composition, wherein said chemical compound comprising at least one (meth)acrylate group and another group selected from one or more of members of the group consisting of phosphine group, phosphine oxide group, phosphate group, phosphonate group, thiol group, tertiary amine group, primary amine group, carboxyl group, hetero cyclic group, silane group, sulfonic acid group, hydroxyl group, phosphonic acid group.

In another aspect, the present invention relates to a composition obtained or obtainable from the process of the present invention.

In another aspect, the present invention relates to a composite, preferably it is a layered composite, derived or derivable from the composition of the present invention.

In another aspect, the present invention relates to a composite, preferably it is a layered composite, containing at least, essentially consisting of or consisting of;
I) a polymer
and
II) a light emitting moiety,
wherein said polymer is derived or derivable from at least one reactive monomer or a mixture of two or more reactive monomers, preferably said monomer having one or more of functional groups, more preferably said monomer is a (meth)acrylate monomer and said polymer;
a 1^{st} chemical compound represented by chemical formula (I^{A}); and
a 2^{nd} chemical compound represented by chemical formula (I^{B}).

Preferably at least a part of the surface of the light emitting moiety is connected to the polymer.

In another aspect, the present invention relates to a process of fabricating the composite, wherein the process comprises at least, essentially consisting of or consisting of, the following steps;
I) providing a composition of the present invention onto a substrate,
II) curing the composition, preferably said curing is performed by photo irradiation and/or thermal treatment.

In another aspect, the present invention relates to a composite, preferably a layered composite obtained or obtainable from the process of fabricating the composite.

In another aspect, the present invention further relates to a color conversion device (100) comprising at least a pixel partly or fully filled with the composite of the present invention comprising at least a matrix material (120) containing a light emitting moiety (110), and a bank (150) comprising at least a polymer material.

In another aspect, the present invention further relates to use of the composition of the present invention for fabricating the composite of the present invention or the device (100) of the present invention.

In another aspect, the present invention also relates to use of the color conversion device (100) of the present invention in an optical device (300) containing at least one functional medium (320) configured to modulate a light or configured to emit light.

In another aspect, the present invention furthermore relates to an optical device (300) containing at least one functional medium (320) configured to modulate a light or configured to emit light; and the composite or the color conversion device (100) of the present invention.

Further advantages of the present invention will become evident from the following detailed description.

### DESCRIPTION OF DRAWINGS

FIG. 1: shows a cross sectional view of a schematic of one embodiment of a color conversion film (100).

FIG. 2: shows a top view of a schematic of another embodiment of a color conversion film (100) of the invention.

FIG. 3: shows a cross sectional view of a schematic of one embodiment of an optical device (300) of the invention.

FIG. 4: shows a cross sectional view of a schematic of another embodiment of an optical device (300) of the invention.

FIG. 5: shows a cross sectional view of a schematic of another embodiment of an optical device (300) of the invention.

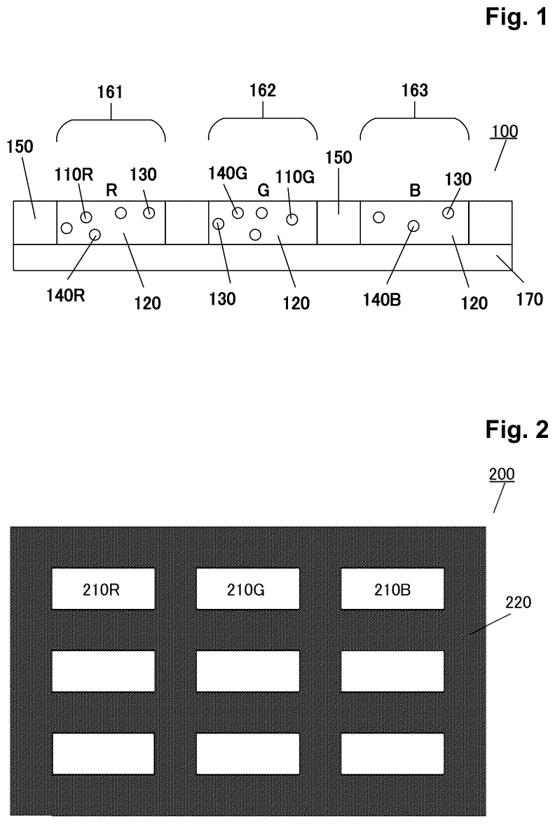

### LIST OF REFERENCE SIGNS IN FIG. 1

100. a color conversion device
110. a light emitting moiety
110R. a light emitting moiety (red)
110G. a light emitting moiety (green)
120. a matrix material
130. a light scattering particle (optional)
140. a coloring agent (optional)
140R. a coloring agent (red) (optional)
140G. a coloring agent (green) (optional)
140B. a coloring agent (blue) (optional)
150. a bank
161. a 1^{st} pixel
162. a 2^{nd} pixel
163. a 3^{rd} pixel
170. a supporting medium (a substrate) (optional)

### LIST OF REFERENCE SIGNS IN FIG. 2

200. a color conversion film
210R. a pixel (red)
210G. a pixel (green)
210B. a pixel (blue)
220. a bank

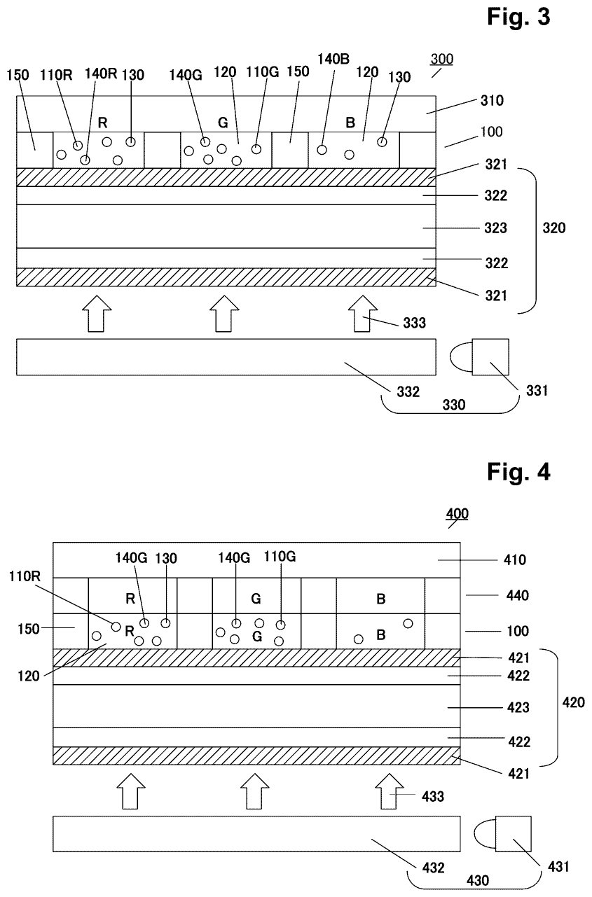

### LIST OF REFERENCE SIGNS IN FIG. 3

300. an optical device
100. a color conversion device
110. a light emitting moiety
110R. a light emitting moiety (red)
110G. a light emitting moiety (green)
120. a matrix material
130. a light scattering particle (optional)
140. a coloring agent (optional)
140R. a coloring agent (red) (optional)
140G. a coloring agent (green) (optional)
140B. a coloring agent (blue) (optional)
150. a bank
310. an optical layer/substrate
320. a light modulator
321. a polarizer
322. an electrode
323. a liquid crystal layer
330. a light source
331. a LED light source
332. a light guiding plate (optional)
333. light emission from the light source (330)

### LIST OF REFERENCE SIGNS IN FIG. 4

400. an optical device
100. a color conversion device
110. a light emitting moiety
110R. a light emitting moiety (red)
110G. a light emitting moiety (green)
120. a matrix material
130. a light scattering particle (optional)
140. a coloring agent (optional)
140R. a coloring agent (red) (optional)
140G. a coloring agent (green) (optional)
140B. a coloring agent (blue) (optional, not mentioned)
150. a bank
410. an optical layer/substrate
420. a light modulator
421. a polarizer
422. an electrode
423. a liquid crystal layer
430. a light source
431. a LED light source
432. a light guiding plate (optional)
433. light emission from the light source (330)
440. a color filter

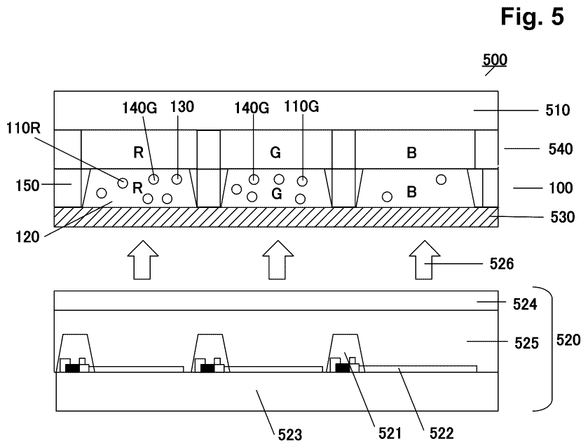

### LIST OF REFERENCE SIGNS IN FIG. 5

500. an optical device
100. a color conversion device
110. a light emitting moiety
110R. a light emitting moiety (red)
110G. a light emitting moiety (green)
120. a matrix material
130. a light scattering particle (optional)
140. a coloring agent (optional)
140R. a coloring agent (red) (optional)
140G. a coloring agent (green) (optional)
140B. a coloring agent (blue) (optional)
150. a bank
510. an optical layer/substrate
520. a light emitting device (e.g., OLED)
521. a TFT
522. an electrode (anode)
523. a substrate
524. an electrode (cathode)
525. light emitting layer (e.g., OLED layer(s))
526. light emission from a light emitting device (520)
530. an optical layer (e.g., polarizer) (optional)
540. a color filter

### DEFINITION OF THE TERMS

In the present specification, symbols, units, abbreviations, and terms have the following meanings unless otherwise specified.

In the present specification, unless otherwise specifically mentioned, the singular form includes the plural form and “one” or “that” means “at least one.” In the present specification, unless otherwise specifically mentioned, an element of a concept can be expressed by a plurality of species, and when the amount (for example, mass % or mol %) is described, it means sum of the plurality of species. “and/or” includes a combination of all elements and also includes single use of the element.

In the present specification, when a numerical range is indicated using “to” or “—”, it includes both endpoints and units thereof are common. For example, 5 to 25 mol % means 5 mol % or more and 25 mol % or less.

In the present specification, the hydrocarbon means one including carbon and hydrogen, and optionally including oxygen or nitrogen. The hydrocarbyl group means a monovalent or divalent or higher valent hydrocarbon. In the present specification, the aliphatic hydrocarbon means a linear, branched or cyclic aliphatic hydrocarbon, and the aliphatic hydrocarbon group means a monovalent or divalent or higher valent aliphatic hydrocarbon. The aromatic hydrocarbon means a hydrocarbon comprising an aromatic ring which may optionally not only comprise an aliphatic hydrocarbon group as a substituent but also be condensed with an alicycle. The aromatic hydrocarbon group means a monovalent or divalent or higher valent aromatic hydrocarbon. Further, the aromatic ring means a hydrocarbon comprising a conjugated unsaturated ring structure, and the alicycle means a hydrocarbon having a ring structure but comprising no conjugated unsaturated ring structure.

In the present specification, the alkyl means a group obtained by removing any one hydrogen from a linear or branched, saturated hydrocarbon and includes a linear alkyl and branched alkyl, and the cycloalkyl means a group obtained by removing one hydrogen from a saturated hydrocarbon comprising a cyclic structure and optionally includes a linear or branched alkyl in the cyclic structure as a side chain.

In the present specification, the aryl means a group obtained by removing any one hydrogen from an aromatic hydrocarbon. The alkylene means a group obtained by removing any two hydrogens from a linear or branched, saturated hydrocarbon. The arylene means a hydrocarbon group obtained by removing any two hydrogens from an aromatic hydrocarbon.

In the present specification, when polymer has a plural type of repeating units, these repeating units copolymerize. These copolymerization are any of alternating copolymerization, random copolymerization, block copolymerization, graft copolymerization, or a mixture of any of these.

According to the present invention, the term “(meth)acrylate polymer” means a methacrylate polymer, an acrylate polymer or a combination of methacrylate polymer and an acrylate polymer.

The term “emission” means the emission of electromagnetic waves by electron transitions in atoms and molecules.

In the present specification, Celsius is used as the temperature unit. For example, 20 degrees means 20 degrees Celsius.

### DETAILED DESCRIPTION OF THE INVENTION

According to the present invention, in one aspect, the composition comprises at least, essentially consisting of or consisting of,
i) at least one reactive monomer or a mixture of two or more reactive monomers, preferably said monomer having one or more of functional groups, more preferably said monomer is a (meth)acrylate monomer;
ii) a light emitting moiety;
iii) a 1^{st} chemical compound represented by following chemical formula (I^{A}); and
iv) a 2^{nd} chemical compound represented by following chemical formula (I^{B}).

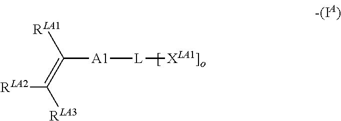

wherein
is 1, 2 or 3, preferably 1;
R^{LA1} is H, D, CN, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms may be replaced by D, F, Cl, Br, I, CN or NO₂;
R^{LA2}, R^{LA3} are, independently of each other, H, D, CN, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; or an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms may be replaced by D, F, Cl, Br, I, CN or NO₂;
R^{a} is at each occurrence, identically or differently, H, D, O, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms; a straight-chain alkenyl or alkynyl group having 2 to 40 carbon atoms, preferably 2 to 24 carbon atoms, more preferably 2 to 12 carbon atoms; a branched alkenyl group or alkynyl group having 3 to 40 carbon atoms, preferably 3 to 24 carbon atoms, more preferably 3 to 12 carbon atoms; an aromatic or heteroaromatic ring system having 5 to 40 aromatic ring atoms, preferably 5 to 25 aromatic ring atoms, more preferably 5 to 18 aromatic ring atoms, wherein in each of the above-mentioned groups one or more H atoms may be replaced by D, F, Cl, Br, I, and where two or more adjacent substituents R^{a} here may optionally form a mono- or polycyclic, aliphatic ring system with one another;
A¹ is

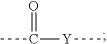

Y is O, N, S, preferably 0 or N;
L is a divalent group selected from a straight-chain alkylene group having 1 to 40 carbon atoms, preferably 3 to 24 carbon atoms, more preferably 4 to 12 carbon atoms; a branched or cyclic alkylene group having 3 to 40 carbon atoms, preferably 4 to 24 carbon atoms, more preferably 5 to 12 carbon atoms; a straight-chain alkenylene or alkynylene group having 2 to 40 carbon atoms, preferably 3 to 24 carbon atoms, more preferably 4 to 12 carbon atoms; or a branched alkenylene group or alkynylene group having 3 to 40 carbon atoms, preferably 4 to 24 carbon atoms, more preferably 5 to 12 carbon atoms, each of which each may be substituted by one or more groups R^{a}, where in each case one or more CH₂ groups may be replaced by an arylene group or heteroarylene group having 5 to 40 aromatic ring atoms, preferably 5 to 25 aromatic ring atoms, more preferably 5 to 18 aromatic ring atoms, Si(R^{a})₂, Ge(R^{a})₂, Sn(R^{a})₂, C═0, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic or heteroaromatic ring system having 5 to 40 aromatic ring atoms, preferably 5 to 25 aromatic ring atoms, more preferably 5 to 18 aromatic ring atoms, an aralkylene group, a heteroaralkylene group, an alkylarylene group or an alkylheteroarylene group, each of which may be substituted by one or more groups R^{a}, and where in each case one or more H atoms may be replaced by D, F, Cl, Br, I, CN, NO₂; or a group represented by the following chemical formula (II) or (II′)

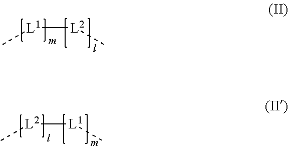

wherein
m is an integer of 1 to 50, preferably 1 to 25, more preferably 2 to 20, and furthermore preferably 4 to 12;
I is 0 or an integer of 1 to 25, preferably 0 or 1 to 20, more preferably 0 or 1 to 12, and furthermore preferably 0 or 1 to 8;
L¹ is

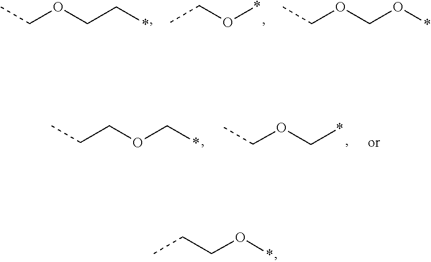

preferably

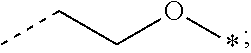

L² is

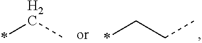

preferably

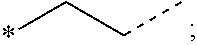

wherein a dashed line indicates a bond to the remainder of the compound and the symbol “*” marks the bond between groups L¹ and L², and wherein each of L¹ and L² may be substituted by one or more groups R^{a}, where one or more CH₂ groups of L¹ and L² may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, NR^{a}, or —C(═O)NR^{a}—, and where one or more H atoms in L¹ and L² may be replaced by D, F, Cl, Br, I, CN or NO₂;
X^{LA1} is, identically or differently on each occurrence, an anchor group preferably selected from —COOM¹, —CO-A³-COOM¹, —OCO-A³-COOM¹, —NCO-A³-COOM¹, —PO(OH)(OM¹), —PO(OM¹)₂, —OC(S)SM¹, —NH₂, —NHR^{a}, —N(R^{a})₂, —SO₃M¹, -SM¹, —Ar¹—SM¹, —OCO-A³-SM¹, —COO-A³-SM¹, —NCO-A³-SM¹, SiOR^{a}, or —N(CS₂M¹)₂;
Ar¹ is a divalent group selected from an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms of the aromatic or heteroaromatic ring system may be replaced by D, F, Cl, Br, I, CN, NO₂;
A³ is a divalent group selected from a straight-chain alkylene group having 1 to 40 carbon atoms, preferably 1 to 25 carbon atoms, more preferably 1 to 15 carbon atoms; a branched or cyclic alkylene group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic or heteroaromatic ring system having 5 to 25 aromatic ring atoms, preferably 5 to 18 aromatic ring atoms, more preferably 5 to 12 aromatic ring atoms, each of which may be substituted by one or more groups R^{a}, and where one or more H atoms of the aromatic or heteroaromatic ring system may be replaced by D, F, Cl, Br, I, CN, NO₂; preferably A³ is not substituted by R^{a} and/or said one or more H atoms is not replaced;
M¹ denotes a hydrogen atom, or a metal cation selected from ½ Mg²⁺, ½ Cu²⁺, ½ Zn²⁺, ½ Pb²⁺, ½ Sn²⁺, ½ Cd²⁺, ⅓ Bi³⁺ or ¼ Sn⁴⁺, preferably a hydrogen atom, ½ Mg²⁺, ½ Cu²⁺, or ½ Zn²⁺, more preferably a hydrogen atom;

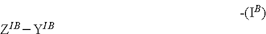

wherein
Z^{IB} is *—R^{x1} or

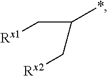

where “*” represents the connecting point to symbol Y of the formula;
R^{x1} is a group selected from one or more members of the group consisting of phosphine group, phosphine oxide group, phosphate group, phosphonate group, thiol group, tertiary amine, carboxyl group, hetero cyclic group, silane group, sulfonic acid, hydroxyl group, phosphonic acid, preferably said group is a phosphonate group, thiol group, a carboxyl group or a combination of any of these, more preferably it is a carboxyl group; and
R^{x2} is a group selected from one or more of members of the group consisting of phosphine group, phosphine oxide group, phosphate group, phosphonate group, thiol group, tertiary amine, carboxyl group, hetero cyclic group, silane group, sulfonic acid, hydroxyl group, phosphonic acid, preferably said group is a phosphonate group, thiol group, a carboxyl group or a combination of any of these, more preferably it is a carboxyl group;
Y^{IB} is a straight-chain alkyl group having carbon atoms 1 to 45 or branched alkyl group having carbon atoms 3 to 45, straight-chain alkenyl group having carbon atoms 1 to 45 or branched alkenyl group having carbon atoms 3 to 45, straight-chain alkoxyl group having carbon atoms 1 to 45 or branched alkoxyl group having carbon atoms 3 to 45, preferably said carbon atoms of the alkyl group, the alkenyl group and/or the alkoxy group are in the range from 10 to 35, more preferably it is from 14 to 30, even more preferably from 16 to 28, furthermore preferably it is from 19 to 26, preferably said alkyl group, alkenyl group and/or alkoxy group may be substituted or unsubstituted, more preferably said alkyl group, alkenyl group and/or alkoxy group, may be substituted by one or more radicals R^{a}, where one or more non-adjacent CH₂ groups may be replaced by R^{a}C═CR^{a}, C≡C, Si(R^{a})₂, Ge(R^{a})₂, Sn(R^{a})₂, C═O, C═S, C═Se, C═NR^{a}, P(═O)(R^{a}), SO, SO₂, NR^{a}, OS, or CONR^{a} and where one or more H atoms may be replaced by D, F, Cl, Br, I, CN or NO₂, preferably Y is a straight-chain or branched alkyl group,
R^{a} is at each occurrence, identically or differently, H, D, 0 or an alkyl group having 1 to 20 carbon atoms, cyclic alkyl or alkoxy group having 3 to 40 carbon atoms, an aromatic ring system having 5 to 60 carbon ring atoms, or a hetero aromatic ring system having 5 to 60 carbon atoms, wherein H atoms may be replaced by D, F, Cl, Br, I; two or more adjacent substituents R^{a} here may also form a mono- or polycyclic, aliphatic, aromatic or heteroaromatic ring system with one another,
wherein Y^{IB} contains at least one carbon-carbon double bond, preferably said chain contains 1 to 5 carbon-carbon double bonds, more preferably 1 to 3 carbon-carbon double bonds, even more preferably 1 to 2 carbon-carbon double bonds in the chain.

### —1^{st} Chemical Compound

It is believed that the 1^{st} chemical compound of the formula (I^{A}) is preferable to control the haze value of the composite (e.g., layer) obtained from the composition. It is also believed that the 1^{st} chemical compound of the formula (I^{A}) may lead higher EQE by optimizing said haze value.

In a preferable embodiment of the present invention, symbol “L” of the formula (I^{A}) is selected from a straight-chain alkylene group having 1 to 40 carbon atoms, preferably 3 to 24 carbon atoms, more preferably 4 to 12 carbon atoms; a branched or cyclic alkylene group having 3 to 40 carbon atoms, preferably 4 to 24 carbon atoms, more preferably 5 to 12 carbon atoms; a straight-chain alkenylene or alkynylene group having 2 to 40 carbon atoms, preferably 3 to 24 carbon atoms, more preferably 4 to 12 carbon atoms; or a branched alkenylene group or alkynylene group having 3 to 40 carbon atoms, preferably 4 to 24 carbon atoms, more preferably 5 to 12 carbon atoms, each of which each may be substituted by one or more groups R^{a}, where in each case one or more CH₂ groups may be replaced by an arylene group or heteroarylene group having 5 to 40 aromatic ring atoms, preferably 5 to 25 aromatic ring atoms, more preferably 5 to 18 aromatic ring atoms, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; or a group represented by chemical formula (II) or (II′);

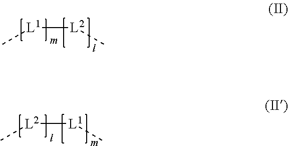

wherein
L¹ is

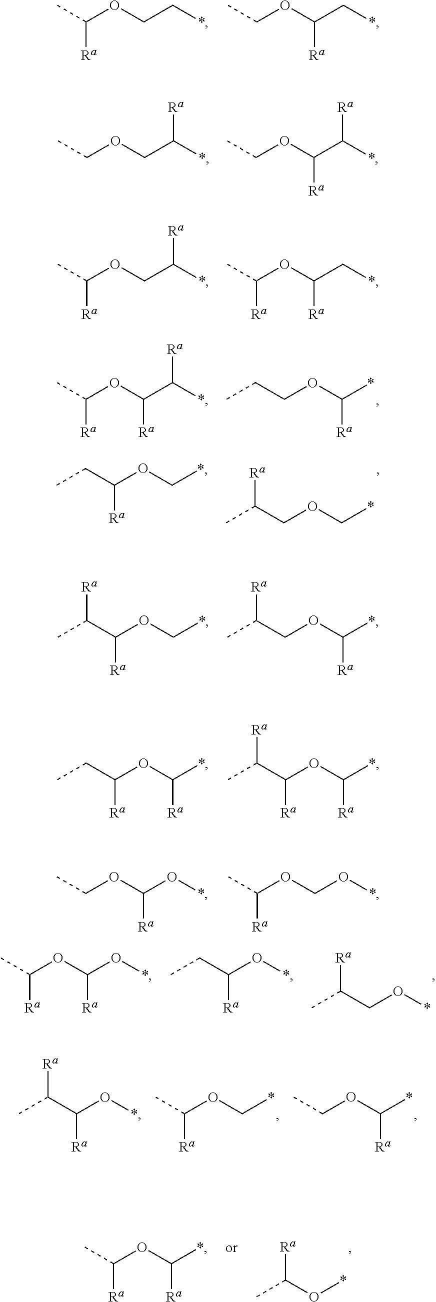

preferably, L¹ is

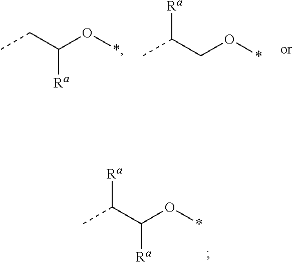

and L² is

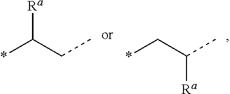

preferably

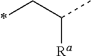

where m, l and R^{a} are as defined above already.

In a further preferable embodiment of the present invention, the compound of chemical formula (I^{A}) is a compound of the following chemical formula (III)

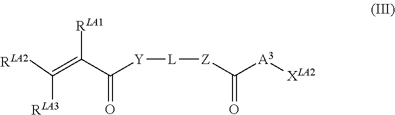

wherein the symbols occurring are as defined in any one of claims 1 to 6, and wherein Z is a direct bond, C, N or O, preferably it is a direct bond, N or O,
X^{LA2} is, —COOM¹ or -SM¹,
More preferably, Z is a direct bond and XLA² is —COOM¹, or Z is N or O and XLA² is -SM¹.

In an even further preferred embodiment of the present invention, the compound of chemical formula (I) or of chemical formula (III) represents a compound of the following chemical formulae (IV), (V-a) or (V-b), preferably chemical formulae (IV), or (V-a),

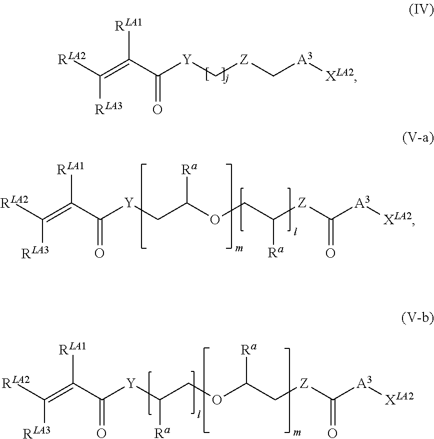

wherein the symbols have the meaning as defined above and index j in chemical formula (IV) is an integer of 1 to 40, preferably 3 to 24, more preferably 4 to 12.

Particularly preferred embodiments of the compound of chemical formula (I) and the compounds of chemical formulae (IV) and (V-a) are the compound represented by the following chemical formulae (IV-1) to (IV-6) and (V-1) to (V-6) or (VI-1) and/or (IV-7), (V-7), (V-8).

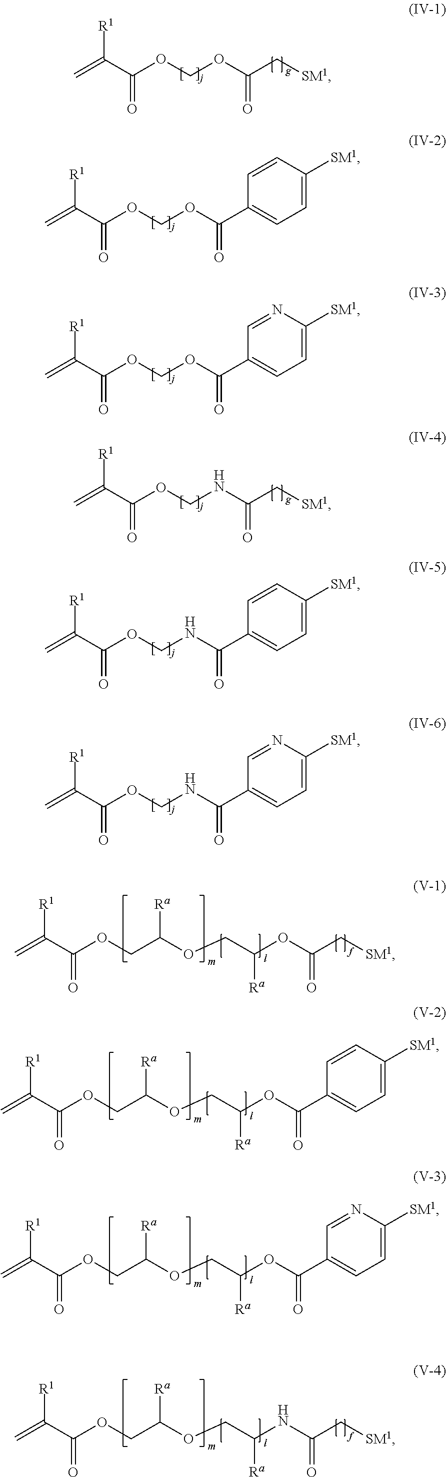

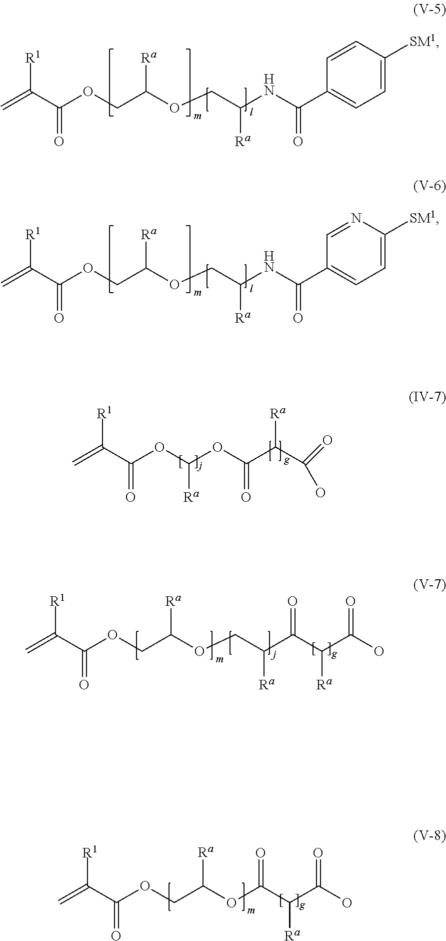

wherein the symbols and indices have the meaning as defined above; and wherein index g and index f of formulae (IV-1) to (IV-6) and (V-1) to (V-6) are each an integer of 1 to 40, preferably 3 to 24, more preferably 4 to 12, index g and index f of the formulae (VI-7), (V-7) and (V-8) are each an integer 1 to 40, preferably 1 to 24, more preferably 2 to 12, even more preferably 2 to 6; and the definition of R¹ is identical to R^{LA1} as already defined above.

Particularly preferably, in the compound of chemical formulae (IV-1) to (IV-6) and (V-1) to (V-6) M¹ is a hydrogen

It is further preferable according to the present invention that the compound of chemical formula (I) has a molecular weight in the range of 150 to 2000 Da. More preferably, it has a molecular weight in the range of 150 to 1500 Da, and even more preferably in the range of 200 to 1000 Da.

As said 1^{st} chemical compound of formula (I^{A}), any publicly known one can be used. For examples, materials disclosed in WO2021/048244 A1 can be used.

Or following compounds can be also used as the 1^{st} chemical compound of formula (I^{A})

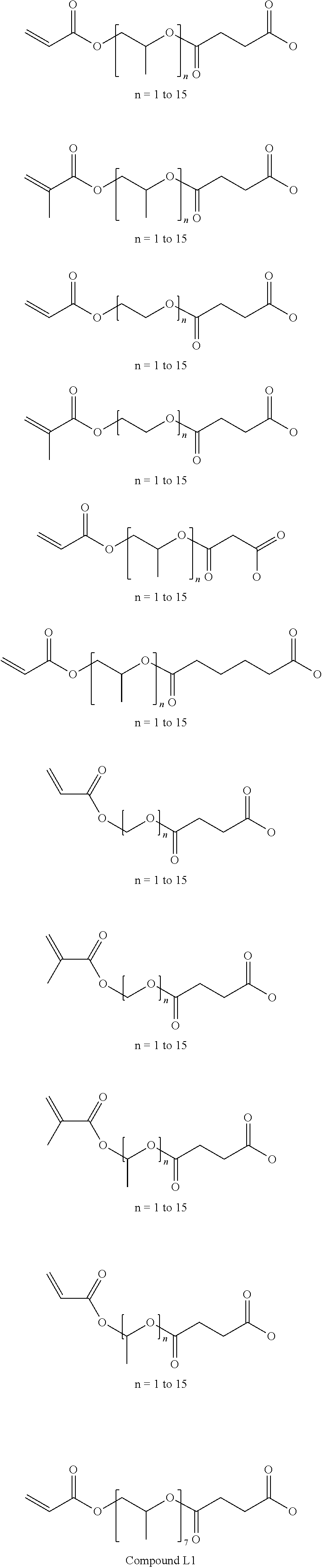

Such chemical compound can be obtained from public or can be synthesized by known method like described in “Preparation Example 1” below.

From the view point of optimizing the haze value of the cured film (composite) obtained from the composition of the present invention and to obtain improved EQE value, the total amount of the 1^{st} chemical compound is preferably in the range from 0.01 to 10 wt %, more preferably from 0.1 to 8 wt %, even more preferably from 0.1 to 5 wt %, particularly preferably it is from 0.5 to 3 wt % based on the total amount of the composition without solvent.

It is believed that adding some amount of the 1^{st} chemical compound, preferably 0.01 wt % or more, can control the haze value of the cured film (composite) made from light emitting moieties and the monomer or a monomer mixture since it may increase the transparency of the obtained film (composite). To avoid too transparent film (composite) and have sufficient Haze value, 10 wt % or less is preferable.

### —2^{nd} Chemical Compound

It is believed that said 2^{nd} chemical compound of formula (I^{B}) realizes improved dispersity of the light emitting moiety, e.g., QD, in a composition containing one reactive monomer or a mixture of two or more reactive monomers. Especially, said 2^{nd} chemical compound realizes good compatibility with the reactive monomer or the mixture of two or more reactive monomers in the composition and leads improved dispersity of the light emitting moiety in the reactive monomer or the mixture of reactive monomers of the composition. Further, it is important to use the 2^{nd} chemical compound together with the 1^{st} chemical compound in the composition to realize improved dispersity of the light emitting nanoparticle, improved compatibility of light emitting nanoparticle with the reactive monomer or the mixture of two or more reactive monomers in the composition, improved EQE and/or QY, and optimized haze value of the composite obtained from the composition, preferably at the same time.

As the 2^{nd} chemical compound of formula (I^{B}), publicly available one can be used. For examples, preferably the chemical compound is selected from the group consisting of 7-Dococenoic acid, Myristoleic acid, Palmitoleic acid, Elaidic acid, Vaccenic acid, Gadoleic acid, Eicosadienoic acid, Docosadienoic acid, a-Linolenic acid, Mead acid, erucic acid or nervonic acid, Oleylamine, more preferably it is selected from Vaccenic acid, Gadoleic acid, Eicosadienoic acid, Docosadienoic acid, a-Linolenic acid, Mead acid, erucic acid or nervonic acid, further more preferably it is selected from Eicosadienoic acid, Docosadienoic acid, a-Linolenic acid, Mead acid, erucic acid or nervonic acid.

From the view point of realizing good compatibility, good dispersibility and/or give improved stability to the light emitting moiety, the total amount of the 2^{nd} chemical compound of formula (I^{B}) is preferably in the range 0.01 to 15 wt %, more preferably 0.1 to 10 wt %, even more preferably from 1 to 8 wt % based on the total amount of the composition without solvent.

The sum of the total amount of the 1^{st} chemical compound and the 2^{nd} chemical compound is preferably in the rage from 0.1 wt % to 15 wt % to realizes the above-mentioned technical effects properly, more preferably from 1 wt % to 10 wt %, even more preferably from 3 to 8 wt % based on the total amount of the composition without solvent.

### —Reactive Monomer

It is believed that the lower viscosity is important to make a low viscosity composition suitable for inkjet printing. Therefore, a (meth)acrylate monomer having the viscosity value within the above-mentioned parameter ranges are especially suitable to make a composition for inkjet printing. By using these (meth)acrylate monomer in a composition, when it is mixed with another material such as semiconducting light emitting nanoparticles with high loading, the composition can still keep lower viscosity within the range suitable for inkjet printing.

In a preferred embodiment of the present invention, the boiling point (B.P.) of said reactive monomer is 80° C. or more, preferably it is in the range from 80° C. to 400° C., even more preferably from 85° C. to 375° C., further more preferably from 90° C. to 350° C. for large area uniform inkjet printing.

It is believed that said high boiling point is also important to make a composition having a lower vapor pressure preferably less than 0.001 mmHg for large area uniform printing, it is preferable to use a reactive monomer, preferably a (meth)acrylate monomer, more preferably a (meth)acrylate monomer of formula (I), (II) and/or (III) having the viscosity value of 25 cP or less at 25° C. and the boiling point at least 80° C. or more, preferably it is in the range from 85° C. to 350° C., more preferably from 100° C. to 350° C. to make a composition suitable for large area uniform inkjet printing even if it is mixed with high loading of another materials such as high loading of semiconducting light emitting nanoparticles.

Here, the term “(meth)acrylate” is a general term for an acrylate and a methacrylate. Therefore, according to the present invention, the term “(meth)acrylate monomer” means a methacrylate monomer and/or an acrylate monomer.

According to the present invention, said B.P can be estimate by the known method such as like described in Science of Petroleum, Vol. 11. p.1281 (1398).

According to the present invention, any types of publicly available acrylates and/or methacrylates represented by chemical formula (I) or (II) can be used preferably.

Especially for the first aspect, any types of publicly available acrylates and/or methacrylates having the viscosity value of 25 cP or less at 25° C. represented by chemical formula (I), (II) and/or (III) can be used.

Thus, according to the present invention, the reactive monomer of the composition is preferably a (meth)acrylate monomer selected from a mono-(meth)acrylate monomer, a di-(meth)acrylate monomer or a tri-(meth)acrylate monomer more preferably it is represented by following chemical formula (11);

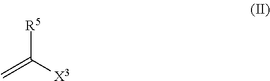

X³ is a non-substituted or substituted alkyl group, aryl group or an alkoxy group;
preferably the symbol X³ is

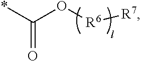

where “*” on the left side of the formula represents the connecting point to the end group C═CR⁵ of the formula (I);
I is 0 or 1;
R⁵ is a hydrogen atom, halogen atom of Cl, Br, or F, methyl group, alkyl group, aryl group, alkoxy group, ester group, or a carboxylic acid group;
R⁶ is a straight alkylene chain or alkoxylene chain having 1 to 25 carbon atoms, preferably R⁶ is a straight alkylene chain or alkoxylene chain having 1 to 15 carbon atoms, more preferably 1 to 5 carbon atoms, which may be substituted by one or more radicals R^{a}, where one or more non-adjacent CH₂ groups may be replaced by R^{a}C═CR^{a}, C≡C, Si(R^{a})₂, Ge(R^{a})₂, Sn(R^{a})₂, C═O, O, C═S, C═Se, C═NR^{a}, P(═O)(R^{a}), SO, SO₂, NR^{a}, OS, or CONR^{a} and where one or more H atoms may be replaced by D, F, Cl, Br, I, CN or NO₂;
R⁷ is a straight alkyl chain or alkoxyl chain having 1 to 25 carbon atoms, preferably R⁷ is a straight alkyl chain or alkoxyl chain having 1 to 15 carbon atoms, more preferably 1 to 5 carbon atoms,
which may be substituted by one or more radicals R^{a}, where one or more non-adjacent CH₂ groups may be replaced by R^{a}C═CR^{a}, C≡C, Si(R^{a})₂, Ge(R^{a})₂, Sn(R^{a})₂, C═O, O, C═S, C═Se, C═NR^{a}, P(═O)(R^{a}), SO, SO₂, NR^{a}, OS, or CONR^{a} and where one or more H atoms may be replaced by D, F, Cl, Br, I, CN or NO₂;
R^{a} is at each occurrence, identically or differently, H, D or an alkyl group having 1 to 20 carbon atoms, cyclic alkyl or alkoxy group having 3 to 40 carbon atoms, an aromatic ring system having 5 to 60 carbon ring atoms, or a hetero aromatic ring system having 5 to 60 carbon atoms, wherein H atoms may be replaced by D, F, Cl, Br, I; two or more adjacent substituents R^{a} here may also form a mono- or polycyclic, aliphatic, aromatic or heteroaromatic ring system with one another.

In a preferable embodiment, the composition further comprises a (meth)acrylate monomer represented by following chemical formula (I) and/or a (meth)acrylate monomer represented by following chemical formula (III);

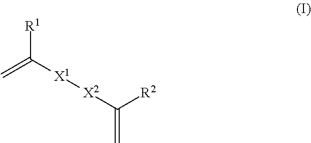

wherein
X¹ is a non-substituted or substituted alkyl group, aryl group or an alkoxy group or an ester group;
X² is a non-substituted or substituted alkyl group, aryl group or an alkoxy group or an ester group;
R¹ is a hydrogen atom, halogen atom of Cl, Br, or F, methyl group, alkyl group, aryl group, alkoxy group, ester group, or a carboxylic acid group;
R² is a hydrogen atom, halogen atom of Cl, Br, or F, methyl group, alkyl group, aryl group, alkoxy group, ester group, or a carboxylic acid group;
preferably the symbol X¹ is

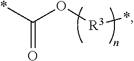

where “*” on the left side of the formula represents the connecting point to the carbon atom of the end group C═CR¹ of the formula (I) and “*” on the right side represents the connecting point to symbol X² of the formula (I);
n is 0 or 1;
preferably the symbol X² is

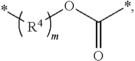

where “*” on the left side of the formula represents the connecting point to symbol X1 of the formula (I) and “*” on the right side represents the connecting point to the end group C═CR² of the formula (I);
m is 0 or 1;
preferably at least m or n is 1;
R³ is a straight or branched alkylene chain or alkoxylene chain having 1 to 25 carbon atoms, a cycloalkane having 3 to 25 carbon atoms or an aryl group having 3 to 25 carbon atoms, preferably R³ is a straight or branched alkylene chain or alkoxylene chain having 1 to 15 carbon atoms, more preferably 1 to 5 carbon atoms,
which may be substituted by one or more radicals R^{a}, where one or more non-adjacent CH₂ groups may be replaced by R^{a}C═CR^{a}, C≡C, Si(R^{a})₂, Ge(R^{a})₂, Sn(R^{a})₂, C═O, O, C═S, C═Se, C═NR^{a}, P(═O)(R^{a}), SO, SO₂, NR^{a}, OS, or CONR^{a} and where one or more H atoms may be replaced by D, F, Cl, Br, I, CN or NO₂;
R⁴ is a straight or branched alkylene chain or alkoxylene chain having 1 to 25 carbon atoms, a cycloalkane having 3 to 25 carbon atoms or an aryl group having 3 to 25 carbon atoms, preferably R⁴ is a straight or branched alkylene chain or alkoxylene chain having 1 to 15 carbon atoms, more preferably 1 to 5 carbon atoms,
which may be substituted by one or more radicals R^{a}, where one or more non-adjacent CH₂ groups may be replaced by R^{a}C═CR^{a}, C≡C, Si(R^{a})₂, Ge(R^{a})₂, Sn(R^{a})₂, C═O, O, C═S, C═Se, C═NR^{a}, P(═O)(R^{a}), SO, SO₂, NR^{a}, OS, or CONR^{a} and where one or more H atoms may be replaced by D, F, Cl, Br, I, CN or NO₂;
R^{a} is at each occurrence, identically or differently, H, D or an alkyl group having 1 to 20 carbon atoms, cyclic alkyl or alkoxy group having 3 to 40 carbon atoms, an aromatic ring system having 5 to 60 carbon ring atoms, or a hetero aromatic ring system having 5 to 60 carbon atoms, wherein H atoms may be replaced by D, F, Cl, Br, I; two or more adjacent substituents R^{a} here may also form a mono- or polycyclic, aliphatic, aromatic or heteroaromatic ring system with one another;

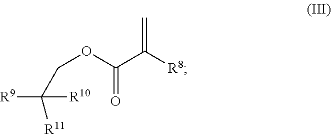

wherein R⁹ is hydrogen atom, a straight alkyl group having 1 to 25 carbon atoms or a (meth)acryl group represented by chemical formula (IV)

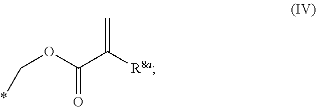

R¹⁰ is hydrogen atom, a straight alkyl group having 1 to 25 carbon atoms or a (meth)acryl group represented by chemical formula (V)

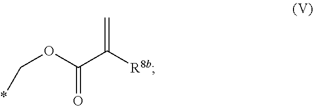

R¹¹ is hydrogen atom, a straight alkyl group having 1 to 25 carbon atoms or a (meth)acryl group represented by chemical formula (VI)

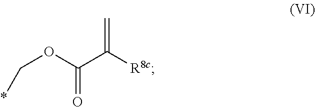

wherein R⁸, R^{8a}, R^{8b} and R^{8c} are, each independently or dependently of each other at each occurrence, H, CH₂CH₃ or CH₃;
wherein at least one of R⁹, R¹⁰ and R¹¹ is a (meth)acryl group, preferably two of R⁹, R¹⁰ and R¹¹ are a (meth)acryl group and other one is a hydrogen atom or a straight alkyl group having 1 to 25 carbon atoms, preferably the electric conductivity (S/cm) of the (meth)acrylate monomer of formula (III) is 1.0*10⁻¹⁰ or less, preferably it is 5.0*10⁻¹¹ or less, more preferably it is in the range from 5.0*10⁻¹¹ to 1.0*10⁻¹⁵, even more preferably it is in the range from 5.0*10⁻¹² to 1.0*10⁻¹⁵.

In a preferred embodiment of the present invention, the (meth)acrylate monomer of chemical formula (II) is in the composition and the mixing ratio of the (meth)acrylate monomer of chemical formula (I) to the (meth)acrylate monomer of chemical formula (II) is in the range from 1:99 to 99:1 (formula (I): formula (II)), preferably from 5:95 to 50:50, more preferably from 10:90 to 40:60, even more preferably it is from 15:85 to 35:65, preferably at least a purified (meth)acrylate monomer represented by chemical formula (I), (II) is used in the composition, more preferably the (meth)acrylate monomer of chemical formula (I) and the (meth)acrylate monomer of chemical formula (II) are both obtained or obtainable by a purification method.

In a preferred embodiment, the boiling point (B.P.) of said (meth)acrylate monomer of chemical formula (I) and/or chemical formula (II) is 80° C. or more, preferably the (meth)acrylate monomers of chemical formula (I) and chemical formula (II) are both 80° C. or more, more preferably it is in the range from 80° C. to 400° C., even more preferably from 85° C. to 375° C., further more preferably from 90° C. to 350° C.

In a preferred embodiment of the present invention, the viscosity of the composition is 35 cP or less at 25° C., preferably in the range from 1 to 35 cP, more preferably from 2 to 30 cP, even more preferably from 2 to 25 cP.

According to the present invention, said viscosity can be measured by rheometer Kinexus Ultra+ (Netzsch) at 25° C. https-//www.netzsch-thermal-analysis.corn/en/products-solutions/rheology/kinexus-ultra/

### —(Meth)Acrylate Monomer Represented by Chemical Formula (1) as a Matrix Material

Furthermore preferably, said R³ of formula (I) and R⁴ of formula (I) are, each independently of each other, selected from the following groups.

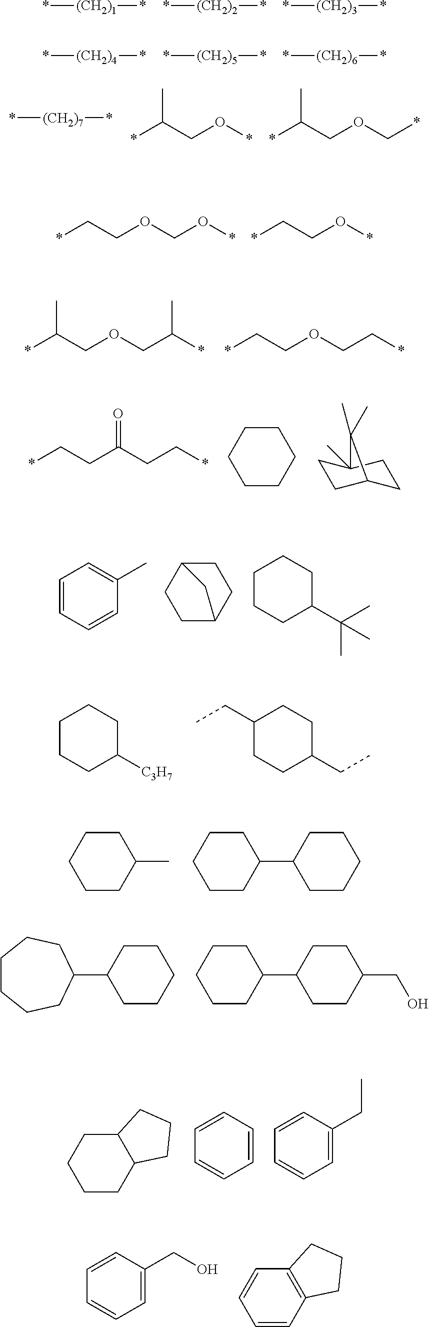

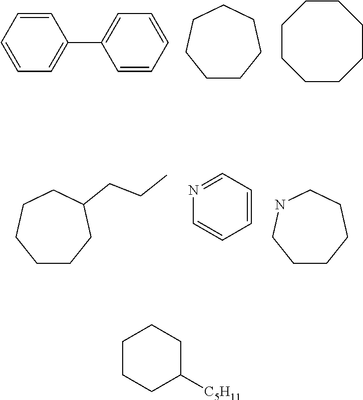

Particularly preferably, said R³ and R⁴ of formula (I) are, at each occurrence independently or differently, selected from the following groups.

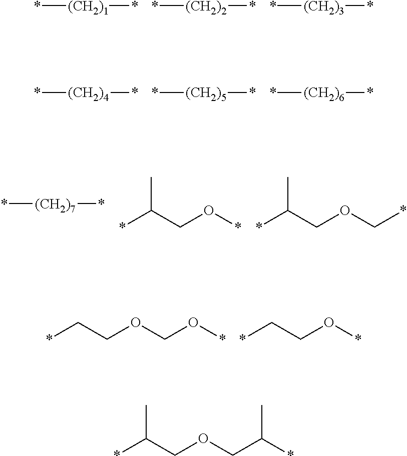

wherein “*” represents the connecting point to oxygen atom of the formula or the connecting point to X² of the formula in case of R³, and wherein “*” represents the connecting point to oxygen atom of the formula or the connecting point to X¹ of the formula in case of R⁴.

Furthermore preferably, said formula (I) is NDDA (nonanediol diacrylate; BP:342° C.), HDDMA (hexanediol dimethacrylate; BP:307), HDDA (hexanediol diacrylate; BP:295° C.) or DPGDA (BP: 314° C.).

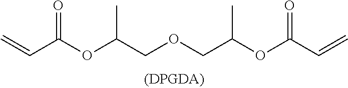 [SMILES: C=CC(=O)OC(C)COCC(C)OC(=O)C=C]

### —(Meth)Acrylate Monomer Represented by Chemical Formula (II)

It is believed that the (meth)acrylate monomer represented by following chemical formula (II) shows much lower viscosity value than the viscosity of the (meth)acrylate monomer of formula (I). Thus, by using the (meth)acrylate monomer represented by chemical formula (II) in combination of the (meth)acrylate monomer of chemical formula (I), a composition having much lower viscosity desirable for smooth inkjet printing can be realized, preferably without decreasing External Quantum Efficiency (EQE) value.

It is believed that said combination can realize a low viscosity composition comprising high amount of another materials, such as high loading of semiconducting light emitting nanoparticles. Thus, it is especially suitable for an inkjet printing when the composition comprises another material.

In a preferable embodiment of the present invention, the boiling point (B.P.) of said (meth)acrylate monomer of chemical formula (II) is 80° C. or more, preferably the (meth)acrylate monomer of chemical formula (II) is in the range from 80° C. to 400° C., more preferably from 85° C. to 375° C., further more preferably from 90° C. to 350° C. for large area uniform inkjet printing.

In a further preferable embodiment of the present invention, the boiling point (B.P.) of said (meth)acrylate monomer of chemical formula (I) and/or the boiling point (B.P.) of said (meth)acrylate monomer of chemical formula (II) is 80° C. or more, preferably the (meth)acrylate monomers of chemical formula (I) and chemical formula (II) are both 80° C. or more, more preferably it is in the range from 80° C. to 400° C., even more preferably from 85° C. to 375° C., further more preferably from 90° C. to 350° C. for large area uniform inkjet printing.

Furthermore preferably, said R⁷ of formula (II) is, at each occurrence, independently or differently, selected from the following groups.

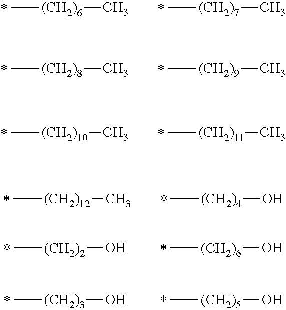

wherein “*” represents the connecting point to R⁶ of X³ in case I is 1, and it is representing the connecting point to oxygen atom of X³ of the formula (II) in case n is 0.

The furthermore preferably, said formula (II) is Lauryl methacrylate (LM, viscosity 6 cP, BP: 142° C.) or Lauryl acrylate (LA, viscosity: 4.0 cP, BP: 313.2° C.).

It is believed that the higher amount of the (meth)acrylate monomer of chemical formula (I) to the total amount of the (meth)acrylate monomer of chemical formula (II) leads improved EQE of the composition, and the mixing weight ratio of the (meth)acrylate monomer of chemical formula (II) to the total amount of the (meth)acrylate monomer of chemical formula (I) less than 50 wt. % is preferable from the view point of viscosity of the composition, better ink-jetting properties of the composition.

Preferably, (meth)acrylate monomers purified by using silica column are used.

It is believed that an impurity removal from the (meth)acrylate monomers by the silica column purification leads improved QY of the semiconducting light emitting nanoparticle in the composition.

### —(Meth)Acrylate Monomer of Chemical Formula (III)

It is believed that the (meth)acrylate monomer of chemical formula (III) is useful to improve hardness/solidity of a layer made from the composition after inkjet printing.

According to the present invention, a publicly known (meth)acrylate monomer represented by following chemical formula (III) can be used to improve hardness/solidity of the layer after inkjet printing and cross linking.

Very preferably, Trimethylolpropane Triacrylate (TMPTA) is used as the (meth)acrylate monomer of chemical formula (III).

In a preferable embodiment of the present invention, the amount of the (meth)acrylate monomer of chemical formula (III) based on the total amount of (meth)acrylate monomers in the composition is in the range from 0.001 wt. % to 25 wt. %, more preferably in the range from 0.1 wt. % to 15 wt. %, even more preferably from 1 wt. % to 10 wt. %, further more preferably from 3 to 7 wt %.

In some embodiments of the present invention, the composition comprises at least the (meth)acrylate monomer of chemical formula (III), the (meth)acrylate monomer of chemical formula (II) and the polymer configured so that said polymer enables to the scattering particles to disperse in the composition, wherein the mixing ratio of the (meth)acrylate monomer of chemical formula (III): the (meth)acrylate monomer of chemical formula (II): the polymer is 1:5:0.01: to 5:4:1.

Preferably, there (meth)acrylate monomers are purified by using silica column, are used.

It is believed that an impurity removal from the (meth)acrylate monomers by the silica column purification leads improved QY of the semiconducting light emitting nanoparticle in the composition.

### —Light Emitting Moiety (110)

In a preferable embodiment of the present invention, said light emitting moiety is an organic light emitting moiety and/or inorganic light emitting moiety, preferably it is an inorganic light emitting moiety, more preferably it is an inorganic light emitting moiety selected from an inorganic phosphor and a quantum material, preferably said light emitting moiety contains a ligand attached onto the outer most surface of the light emitting moiety, more preferably said ligand is the chemical compound of chemical formula (I^{A}) and/or the chemical compound of chemical formula (I^{B}).

In some embodiments of the present invention, the total amount of the light emitting moiety (110) is in the range from 0.1 wt. % to 90 wt. % based on the total amount of a pixel, preferably said pixel is a 1^{st} pixel (161) and/or a 2nd pixel (162), preferably from 10 wt. % to 70 wt. %, more preferably from 20 wt. % to 60 wt. %. Preferably, said light emitting moiety is configured to emit light having peak maximum light wavelength in the range from 400 to 900, more preferably from 500 to 850 nm, even more preferably from 510 to 820 nm.

In a preferred embodiment of the present invention, in case of the light emitting moiety is an inorganic light emitting material, the average diameter of the inorganic part of the light emitting moiety is in the range from 1 nm to 18 nm, preferably it is from 2 to 15 nm, more preferably it is from 3 to 12 nm.

Thus, in some embodiments of the present invention, said light emitting moiety is an organic light emitting moiety and/or inorganic light emitting moiety, preferably it is an inorganic light emitting moiety, more preferably it is an inorganic light emitting moiety is an inorganic phosphor or a quantum material, preferably said light emitting moiety contains a ligand attached onto the outer most surface of the light emitting moiety, more preferably said ligand is the chemical compound of the present invention and/or it is at least one straight-chain or branched chain alkyl group having carbon atoms 1 to 45, straight-chain or branched chain alkenyl group having carbon atoms 1 to 45 or straight-chain or branched chain alkoxyl group having carbon atoms 1 to 45.

—iii) Semiconducting Light Emitting Nanoparticle

According to the present invention, the term “semiconductor” means a material that has electrical conductivity to a degree between that of a conductor (such as copper) and that of an insulator (such as glass) at room temperature. Preferably, a semiconductor is a material whose electrical conductivity increases with the temperature.

The term “nanosized” means the size in between 0.1 nm to 150 nm, more preferably 3 nm to 50 nm.

Thus, according to the present invention, “semiconducting light emitting nanoparticle” is taken to mean that the light emitting material which size is in between 0.1 nm to 150 nm, more preferably 3 nm to 50 nm, having electrical conductivity to a degree between that of a conductor (such as copper) and that of an insulator (such as glass) at room temperature, preferably, a semiconductor is a material whose electrical conductivity increases with the temperature, and the size is in between 0.1 nm and 150 nm, preferably 0.5 nm to 150 nm, more preferably 1 nm to 50 nm.

According to the present invention, the term “size” means the average diameter of circle with an area equal to an average area of dark contrast features in TEM image.

The average diameter of the semiconducting nanosized light emitting particles is calculated based on 100 semiconducting light emitting nanoparticles in a TEM image created by a Tecnai G2 Spirit Twin T-12 Transmission Electron Microscope.

In a preferred embodiment of the present invention, the semiconducting light emitting nanoparticle of the present invention is a quantum sized material.

According to the present invention, the term “quantum sized” means the size of the semiconducting material itself without ligands or another surface modification, which can show the quantum confinement effect, like described in, for example, ISBN:978-3-662-44822-9.

For example, CdS, CdSe, CdTe, ZnS, ZnSe, ZnSeS, ZnTe, ZnO, GaAs, GaP, GaSb, HgS, HgSe, HgSe, HgTe, InAs, InP, InPZn, InPZnS, InPZnSe, InPZnSeS, InPZnGa, InPGaS, InPGaSe, InPGaSeS, InPZnGaSeS and InPGa, InCdP, InPCdS, InPCdSe, InSb, AlAs, AlP, AlSb, Cu₂S, Cu₂Se, CuInS2, CuInSe₂, Cu₂(ZnSn)S₄, Cu₂(InGa)S₄, TiO₂ alloys and a combination of any of these can be used.

In a preferred embodiment of the present invention, the 1^{st} semiconducting material comprises at least one element of the group 13 of the periodic table, and one element of the group 15 of the periodic table, preferably the element of the group 13 is In, and the element of the group 15 is P, more preferably the 1^{st} semiconducting material is selected from the group consisting of InP, InPZn, InPZnS, InPZnSe, InPZnSeS, InPZnGa, InPGaS, InPGaSe, InPGaSeS, InPZnGaSeS and InPGa.

According to the present invention, a type of shape of the core of the semiconducting light emitting nanoparticle, and shape of the semiconducting light emitting nanoparticle to be synthesized are not particularly limited.

For examples, spherical shaped, elongated shaped, star shaped, polyhedron shaped, pyramidal shaped, tetrapod shaped, tetrahedron shaped, platelet shaped, cone shaped, and irregular shaped core and—or a semiconducting light emitting nanoparticle can be synthesized.

In some embodiments of the present invention, the average diameter of the core is in the range from 1.5 nm to 3.5 nm.

The average diameter of the core is calculated based on 100 semiconducting light emitting nanoparticles in a TEM image created by a Tecnai G2 Spirit Twin T-12 Transmission Electron Microscope by measuring the longest axis of each single particles.

In some embodiments of the present invention, at least one shell layer comprises or a consisting of a 1^{st} element of group 12 of the periodic table and a 2^{nd} element of group 16 of the periodic table, preferably, the 1^{st} element is Zn, and the 2^{nd} element is S, Se, or Te; preferably a first shell layer covering directly onto said core comprises or a consisting of a 1^{st} element of group 12 of the periodic table and a 2^{nd} element of group 16 of the periodic table, preferably, the 1^{st} element is Zn, and the 2^{nd} element is S, Se, or Te.

In a preferred embodiment of the present invention, at least one shell layer (a first shell layer) is represented by following formula (XI), preferably the shell layer directly covering the core is represented by the chemical formula (XI);

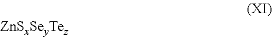

wherein 0≤x≤1, 0≤y≤1, 0≤z≤1, and x+y+z=1, preferably 0≤x≤1, 0≤y≤1, z=0, and x+y=1, preferably, the shell layer is ZnSe, ZnS, ZnSₓSe_{y}, ZnSe_{y}Te_{z} or ZnSₓTe_{z}.

In some embodiments of the present invention, said shell layer is an alloyed shell layer or a graded shell layer, preferably said graded shell layer is ZnSₓSe_{y}, ZnSe_{y}Te_{z}, or ZnSₓTe_{z}, more preferably it is ZnSₓSe_{y}.

In some embodiments of the present invention, the semiconducting light emitting nanoparticle further comprises 2^{nd} shell layer onto said shell layer, preferably the 2^{nd} shell layer comprises or a consisting of a 3^{rd} element of group 12 of the periodic table and a 4^{th} element of group 16 of the periodic table, more preferably the 3^{rd} element is Zn, and the 4^{th} element is S, Se, or Te with the proviso that the 4^{th} element and the 2^{nd} element are not same.

In a preferred embodiment of the present invention, the 2^{nd} shell layer is represented by following formula (XI′),

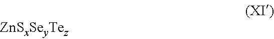

wherein 0≤x≤1, 0≤y≤1, 0≤z≤1, and x+y+z=1, preferably, the shell layer is ZnSe, ZnSₓSe_{y}, ZnSe_{y}Te_{z}, or ZnSₓTe_{z} with the proviso that the shell layer and the 2^{nd} shell layer is not the same.

In some embodiments of the present invention, said 2^{nd} shell layer can be an alloyed shell layer.

In some embodiments of the present invention, the semiconducting light emitting nanoparticle can further comprise one or more additional shell layers onto the 2^{nd} shell layer as a multishell.

According to the present invention, the term “multishell” stands for the stacked shell layers consisting of three or more shell layers.

For example, CdSe/CdS, CdSeS/CdZnS, CdSeS/CdS/ZnS, ZnSe/CdS, CdSe/ZnS, InP/ZnS, InP/ZnSe, InP/ZnSe/ZnS, InZnP/ZnS, InZnP/ZnSe, InZnP/ZnSe/ZnS, InGaP/ZnS, InGaP/ZnSe, InGaP/ZnSe/ZnS, InZnPS/ZnS, InZnPS/ZnSe, InZnPS/ZnSe/ZnS, ZnSe/CdS, ZnSe/ZnS or combination of any of these, can be used. Preferably, InP/ZnS, InP/ZnSe, InP/ZnSe/ZnS, InZnP/ZnS, InZnP/ZnSe, InZnP/ZnSe/ZnS, InGaP/ZnS, InGaP/ZnSe, InGaP/ZnSe/ZnS.

Such semiconducting light emitting nanoparticles are publicly available (for example from Sigma Aldrich) and/or can be synthesized with the method described for example in U.S. Pat. Nos. 7,588,828 B, 8,679,543 B and Chem. Mater. 2015, 27, pp 4893-4898.

### —Ligands

In some embodiments of the present invention, optionally and additionally, the light emitting moiety can be directly over coated by one or more ligands, or the outer most surface of the inorganic part of the semiconducting light emitting nanoparticle can be directly coated by one or more of the additional ligands. As an option, ligand coated semiconducting light emitting nanoparticle can be overcoated by a polymer forming a polymer bead having said semiconducting light emitting nanoparticle(s) inside.

As the ligands, phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), Octadecylphosphonic acid (ODPA), and Hexylphosphonic acid (HPA); amines such as Oleylamine, Dodecyl amine (DDA), Tetradecyl amine (TDA), Hexadecyl amine (HDA), and Octadecyl amine (ODA), Oleylamine (OLA), 1-Octadecene (ODE), thiols such as hexadecane thiol, dodecane thiol and hexane thiol; mercapto carboxylic acids such as mercapto propionic acid and mercaptoundecanoicacid; carboxylic acids such as oleic acid, stearic acid, myristic acid; acetic acid, Polyethylenimine (PEI), monofunctional polyethylene glycol PEG thiol (mPEG-thiol) or a derivatives of mPEG thiol, PEG carboxylate and a combination of any of these can be used.

Examples of such ligands have been described in, for example, the laid-open international patent application No. WO 2012/059931A.

### —Composition

In some embodiments of the present invention, the composition comprises two or more semiconducting light emitting nanoparticles.

In some embodiments of the present invention, the composition comprises a plurality of semiconducting light emitting nanoparticles.

In some embodiments of the present invention, the total amount of the semiconducting light emitting nanoparticles is in the range from 0.1 wt. % to 90 wt. % based on the total amount of the composition, preferably from 10 wt. % to 70 wt. %, more preferably from 20 wt. % to 60 wt. %.

According to the present invention, preferably the composition is configured to show the EQE value 23% or more, preferably 24% or more and less than 50%.

According to the present invention, said EQE is measured by the following EQE measurement process at room temperature which is based on using an integrating sphere, equipped with a 450 nm excitation light source coupled in via an optical fiber, and a spectrometer (C9920, Hamamatsu photonics), and which consists of a first measurement using air as the reference to detect the incident photons of the excitation light and a second measurement with the sample or test cell placed in front of the integrating sphere in between the opening of the integrating sphere and the exit of the optical fiber to detect the photons incident from the excitation light source transmitted through the sample and the photos emitted from the sample or test cell, whereas for both cases photons exiting the integrating sphere are counted by the spectrometer and EQE and BL calculation is done with the following equations and the number of photons of the excitation light and emission light is calculated by integration over the following wavelength ranges;
EQE=Photons [Emission light]/Photons [Excitation light measured without sample in place];
BL=Photons [Excitation light measured with sample in place]/Photons [Excitation light measured without sample in place];
Emission light if green light emitting moieties are used: 490 nm-580 nm,
Emission light if red light emitting moieties are used: 580 nm-780 nm
Excitation light: 390 nm-490 nm can be used. Excitation light for red light emitting moieties: 430 nm-470 nm is suitable.

According to the present invention, in a preferred embodiment, the viscosity of the composition is 35 cP or less at 25° C., preferably in the range from 1 to 35 cP, more preferably from 2 to 35 cP, even more preferably from 2 to 30 cP.

In a preferred embodiment of the present invention, the composition comprises a solvent 10 wt % or less based on the total amount of the composition, more preferably it is 5 wt % or less, more preferably it is a solvent free composition, preferably the composition does not comprise any one of the following solvent selected from one or more members of the group consisting of ethylene glycol monoalkyl ethers, such as, ethylene glycol monomethyl ether, ethylene glycol monoethyl ether, ethylene glycol monopropyl ether, and ethylene glycol monobutyl ether; diethylene glycol dialkyl ethers, such as, diethylene glycol dimethyl ether, diethylene glycol diethyl ether, diethylene glycol dipropyl ether, and diethylene glycol dibutyl ether; propylene glycol monoalkyl ethers, such as, propylene glycol monomethyl ether(PGME), propylene glycol monoethyl ether, and propylene glycol monopropyl ether; ethylene glycol alkyl ether acetates, such as, methyl cellosolve acetate and ethyl cellosolve acetate; propylene glycol alkyl ether acetates, such as, propylene glycol monomethyl ether acetate (PGMEA), propylene glycol monoethyl ether acetate, and propylene glycol monopropyl ether acetate; ketones, such as, methyl ethyl ketone, acetone, methyl amyl ketone, methyl isobutyl ketone, and cyclohexanone; alcohols, such as, ethanol, propanol, butanol, hexanol, cyclo hexanol, ethylene glycol, triethylene glycol and glycerin; esters, such as, ethyl 3-ethoxypropionate, methyl 3-methoxypropionate and ethyl lactate; and cyclic asters, such as, gamma-butyro-lactone; chlorinated hydrocarbons, such as chloroform, dichloromethane, chlorobenzene, trimethyl benzenes such as 1,3,5-trimethylbenzene, 1,2,4-trimethyl benzene, 1,2,3-trimethyl benzene, docecylbenzene, cyclohexylbenzene, 1,2,3,4-tetramethylbenzene, 1,2,3,5-tetramethylbenzene, 3-isopropylbiphenyl, 3-methylbiphenyl, 4-methylbiphenyl and dichlorobenzene, preferably said solvent is propylene glycol alkyl ether acetates, alkyl acetates, ethylene glycol monoalkyl ethers, propylene glycol, and propylene glycol monoalkyl ethers.

It is believed that the less than 10 wt % of solvent in the composition leads improved ink-jetting and it can avoid 2^{nd} or more ink-jetting onto the same pixel after evaporation of the solvent.

According to the present invention, it is desirable not to add any solvent to realize large area inkjet printing with improved uniformity without causing any clogging at a nozzle and/or with good dispersity of semiconducting light emitting nanoparticles and/or with good dispersity of scattering particles.

According to the present invention, preferably the composition further comprises another material selected from one or more members of the group consisting of;
another light emitting moiety which is different from the light emitting moiety, preferably said light emitting moiety comprises a ligand, more preferably said light emitting moiety comprises an alkyl or alkenyl type ligand having carbon atoms 2 to 25; a (meth)acrylate monomer different from the (meth)acrylate monomer the present invention, scattering particles, transparent polymers, anti-oxidants, radical quenchers, photo initiators and surfactants. More preferably, said composition comprises another material selected from one or more members of the group consisting of; a (meth)acrylate monomer different from the (meth)acrylate monomer of embodiment 8; scattering particles, transparent polymers, antioxidants, radical quenchers, a photo initiators and surfactants.

In some embodiments of the present invention, preferably the composition of the present invention comprises a scattering particle in the range from 0 to 5 wt %, more preferably from 0 to 1 wt %, even more preferably the composition does not contain any scattering particle.

According to the present invention, said scattering particle means a publicly known small particle of inorganic oxides such as SiO₂, SnO₂, CuO, CoO, Al₂O₃TiO₂, Fe₂O₃, Y₂O₃, ZnO, ZnS, MgO; organic particles such as polymerized polystyrene, polymerized PMMA; inorganic hollow oxides such as hollow silica or a combination of any of these.

According to the present invention, the term “transparent” means at least around 60% of incident light transmit at the thickness used in an optical medium and at a wavelength or a range of wavelength used during operation of an optical medium. Preferably, it is over 70%, more preferably, over 75%, the most preferably, it is over 80%.

According to the present invention the term “polymer” means a material having a repeating unit and having the weight average molecular weight (Mw) 1000 g/mol, or more.

The molecular weight MW is determined by means of GPC(=gel permeation chromatography) against an internal polystyrene standard.

In some embodiments of the present invention, the glass transition temperature (Tg) of the transparent polymer is 70° C. or more and 250° C. or less.

Tg is measured based on changes in the heat capacity observed in Differential scanning colorimetry like described in Rickey J Seyler, Assignment of the Glass Transition, ASTM publication code number (PCN) 04-012490-50.

For example, as the transparent polymer for the transparent matrix material, poly(meth)acrylates, epoxys, polyurethanes, polysiloxanes, can be used preferably.

In a preferred embodiment of the present invention, the weight average molecular weight (Mw) of the polymer as the transparent matrix material is in the range from 1,000 to 300,000 g/mol, more preferably it is from 10,000 to 250,000 g/mol.

According to the present invention, publicly known antioxidants, radical quenchers, photo initiators and/or surfactants can be used preferably like described in WO 2016/134820A.

### —Process

In another aspect, the invention also relates to a process for fabricating the composition of the present invention comprising at least, essentially consisting or consisting of, the following step Y1 or Y2;
Y1) mixing at least one light emitting moiety, at least one reactive monomer or a mixture of two or more reactive monomers, preferably said monomer having one or more of functional groups, more preferably said monomer is a (meth)acrylate monomer;
a 1^{st} chemical compound represented by the chemical formula (I^{A}); and/or
a 2^{nd} chemical compound represented by the chemical formula (I^{B}) to form the composition.
Y2) mixing at least one light emitting moiety, at least one reactive monomer or a mixture of two or more reactive monomers, preferably said monomer having one or more of functional groups, more preferably said monomer is a (meth)acrylate monomer;
wherein said light emitting nanoparticle has a 1^{st} ligand from the 1^{st} chemical compound represented by the chemical formula (I^{A}); and/or a 2^{nd} ligand from a 2^{nd} chemical compound represented by the chemical formula (I^{B}) preferably in step Y1, a 1^{st} chemical compound represented by the chemical formula (I^{A}); and/or
a 2^{nd} chemical compound represented by the chemical formula (I^{B}) to form the composition can be attached as a ligand directly onto the light emitting moiety, preferably in step Y2, a 1^{st} chemical compound represented by the chemical formula (I^{A}); and/or
a 2^{nd} chemical compound represented by the chemical formula (I^{B}) to form the composition can be further added and mixed.

In one embodiment of the present invention, the process comprises a purification step of the light emitting moieties after mixing with the chemical compound and before adding a reactive monomer.

More details of the composition such as “reactive monomer”, “light emitting moiety” and “chemical compound” are described above such as in the section of “reactive monomer”, “light emitting moiety” and “chemical compound”.

Additional additives as described in the section of “additional material” can be mixed.

In another aspect, the invention also relates to a composition obtained or obtainable from the process for fabricating the composition identified above.

### —Layered Composite

In another aspect, the invention also relates to a composite, preferably it is a layered composite, derived or derivable from one or more of the compositions of the present invention.

In another aspect, the invention also relates to a composite, preferably it is a layered composite, containing at least;
I) a polymer
and
II) a light emitting moiety,
wherein said polymer is derived or derivable from at least one reactive monomer or a mixture of two or more reactive monomers, preferably said monomer having one or more of functional groups, more preferably said monomer is a (meth)acrylate monomer and said polymer;
a 1^{st} chemical compound represented by the chemical formula (I^{A}); and
a 2^{nd} chemical compound represented by the chemical formula (I^{B}).

Preferably at least a part of the surface of the light emitting moiety is connected to the polymer.

In a preferable embodiment of the present invention, said composite being a layered composite, has the average layer thickness in the range from 1 to 50 um, preferably 5 to 15, more preferably 8 to 15, furthermore preferably 8-12 um.

Further preferably, said composition is configured to show the EQE value 25% or more, preferably 30% or more and less than 50%.

In another aspect, the invention also relates to a process of fabricating the composite of the present invention, wherein the process comprises at least the following steps;
I) providing a composition of the embodiments onto a substrate,
II) curing the composition, preferably said curing is performed by photo irradiation and/or thermal treatment.

A composite, preferably a layered composite obtained or obtainable from the process of fabricating the composite of the present invention indicated above.

In another aspect, the present invention also relates to a method for fabricating a color conversion device (100) of the present invention, containing at least the following steps, preferably in this sequence,
Xi) Providing a bank composition onto a surface of a supporting medium
Xii) Curing the bank composition,
Xiii) Applying photo-patterning to the cured said composition to fabricate bank and a patterned pixel region,
Xiv) Providing the composition of the present invention to at least one pixel region, preferably by ink-jetting,
Xv) Curing the composition, preferably said color conversion device (100) further contains a supporting medium (170).

### —Use of the Composition/Composite

In another aspect, the present invention further relates to a use of the composition, or the composite of the present invention, in an electronic device, optical device, sensing device or in a biomedical device or for fabricating an electronic device, sensing device, optical device or a biomedical device.

### —Color Conversion Device (100)

In another aspect, the present invention also relates to a color conversion device (100) comprising at least a pixel, preferably said pixel is a 1^{st} pixel (161) or a 2^{nd} pixel (162), partly or fully filled with the layer of the present invention comprising at least a matrix material (120) containing a light emitting moiety (110), and a bank (150) comprising at least a polymer material, preferably the color conversion device (100) further contains a supporting medium (170).

### —Pixel

According to the present invention, said pixel comprises at least a matrix material (120) containing a light emitting moiety (110) preferably said pixel is a 1^{st} pixel (161) or a 2^{nd} pixel (162). In a preferable embodiment, the pixel is a solid layer obtained or obtainable by curing the composition of the present invention containing at least one acrylate monomer together with at least one light emitting moiety (110), preferably said curing is a photo curing by photo irradiation, thermal curing or a combination of a photo curing and a thermal curing.

In a preferred embodiment of the present invention, the layer thickness of the pixel is in the range from 0.1 to 100 μm, preferably it is from 1 to 50 μm, more preferably from 5 to 25 μm.

In some embodiments of the present invention, the color conversion device (100) further contains a 2^{nd} pixel (162), preferably the device (100) contains at least said 1^{st} pixel (161), 2^{nd} pixel (162) and a 3^{rd} pixel (163), more preferably said 1^{st} pixel (161) is a red color pixel, the 2^{nd} pixel (162) is a green color pixel and the 3^{rd} pixel (163) is a blue color pixel, even more preferably the 1^{st} pixel (161) contains a red light emitting moiety (110R), the 2^{nd} color pixel (162) contains a green light emitting moiety (110G) and the 3^{rd} pixel (163) does not contain any light emitting moiety.

In some embodiments of the present invention, said 1^{st} pixel (161) consists of one pixel or two or more sub-pixels configured to emit red color when irradiated by an excitation light, more preferably said sub-pixels contains the same light emitting moiety (110).

### —Matrix Material (120)

In a preferable embodiment, the matrix material (120) contains a (meth)acrylate polymer, preferably it is a methacrylate polymer, an acrylate polymer or a combination of thereof, more preferably it is an acrylate polymer, even more preferably said matrix material (120) is obtained or obtainable from the composition of the present invention containing at least one acrylate monomer, further more preferably said matrix material (120) is obtained or obtainable from the composition of the present invention containing at least one di-acrylate monomer, particularly preferably said matrix material (120) is obtained or obtainable from the composition of the present invention containing at least one di-acrylate monomer and a mono-acrylate monomer, preferably said composition is a photosensitive composition.

### —Bank (150)

In some embodiments of the present invention, the height of the bank (150) is in the range from 0.1 to 100 μm, preferably it is from 1 to 50 μm, more preferably from 1 to 25 μm, furthermore preferably from 5 to 20 μm.

In a preferred embodiment of the present invention, the bank (150) is configured to determine the area of said pixel, preferably said pixel is a 1^{st} pixel (161) or a 2^{nd} pixel (162), and at least a part of the bank (150) is directly contacting to at least a part of the pixel, preferably said 2^{nd} polymer of the bank (150) is directly contacting to at least a part of the 1^{st} polymer of the 1^{st} pixel (161).

More preferably, said bank (150) is photolithographically patterned and said 1^{st} pixel (161) is surrounded by the bank (150), preferably said 1^{st} pixel (161), the 2^{nd} pixel (162) and the 3^{rd} pixel (163) are all surrounded by the photolithographically patterned bank (150).

In another aspect, the present invention further relates to a color conversion device (100) obtainable or obtained from the method of the present invention.

### —Use

In another aspect, the present invention further relates to use of the color conversion device (100) of the present invention in an optical device (300) containing at least one functional medium (320, 420, 520) configured to modulate a light or configured to emit light.

### —Optical Device

In another aspect, the present invention further relates to an optical device (300) containing at least one functional medium (320, 420, 520) configured to modulate a light or configured to emit light, and the composite, or the color conversion device (100) of the present invention.

In some embodiments of the present invention, said optical device can be a liquid crystal display device (LCD), Organic Light Emitting Diode (OLED), Light Emitting Diode device (LED), Micro LED, Micro Electro Mechanical Systems (here in after “MEMS”), electro wetting display, or an electrophoretic display.

Therefore, in a preferred embodiment, said functional medium can be a LC layer, OLED layer, LED layer, micro LED layer, MEMS layer, electro wetting layer and/or an electrophoretic layer. More preferably it is a LC layer, micro LED layer or an OLED layer.

### Preferable Embodiments

1. A composition, preferably it is being of a photocurable composition, more preferably it is being a photocurable composition for ink-jetting, comprising at least, essentially consisting of or consisting of;
i) at least one reactive monomer or a mixture of two or more reactive monomers, preferably said monomer having one or more of functional groups, more preferably said monomer is a (meth)acrylate monomer;
ii) a light emitting moiety;
iii) a 1^{st} chemical compound represented by following chemical formula (I^{A}); and
iv) a 2^{nd} chemical compound represented by following chemical formula (I^{B}).

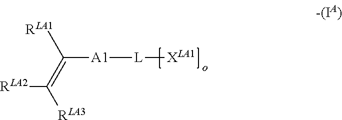

wherein
o is 1, 2 or 3, preferably 1;
R^{LA1} is H, D, CN, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms may be replaced by D, F, Cl, Br, I, CN or NO₂;
R^{LA2}, R^{LA3} are, independently of each other, H, D, CN, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; or an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms may be replaced by D, F, Cl, Br, I, CN or NO₂;
R^{a} is at each occurrence, identically or differently, H, D, a straight chain alkyl or alkoxy group having 1 to 40 carbon atoms, preferably 1 to 25 carbon atoms, more preferably 1 to 15 carbon atoms; a branched or cyclic alkyl or alkoxy group having 3 to 40 carbon atoms, preferably 3 to 25 carbon atoms, more preferably 3 to 15 carbon atoms; a straight-chain alkenyl or alkynyl group having 2 to 40 carbon atoms, preferably 2 to 24 carbon atoms, more preferably 2 to 12 carbon atoms; a branched alkenyl group or alkynyl group having 3 to 40 carbon atoms, preferably 3 to 24 carbon atoms, more preferably 3 to 12 carbon atoms; an aromatic or heteroaromatic ring system having 5 to 40 aromatic ring atoms, preferably 5 to 25 aromatic ring atoms, more preferably 5 to 18 aromatic ring atoms, wherein in each of the above-mentioned groups one or more H atoms may be replaced by D, F, Cl, Br, I, and where two or more adjacent substituents R^{a} here may optionally form a mono- or polycyclic, aliphatic ring system with one another;
A¹ is

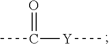

Y is O, N, S, preferably 0 or N;
L is a divalent group selected from a straight-chain alkylene group having 1 to 40 carbon atoms, preferably 3 to 24 carbon atoms, more preferably 4 to 12 carbon atoms; a branched or cyclic alkylene group having 3 to 40 carbon atoms, preferably 4 to 24 carbon atoms, more preferably 5 to 12 carbon atoms; a straight-chain alkenylene or alkynylene group having 2 to 40 carbon atoms, preferably 3 to 24 carbon atoms, more preferably 4 to 12 carbon atoms; or a branched alkenylene group or alkynylene group having 3 to 40 carbon atoms, preferably 4 to 24 carbon atoms, more preferably 5 to 12 carbon atoms, each of which each may be substituted by one or more groups R^{a}, where in each case one or more CH₂ groups may be replaced by an arylene group or heteroarylene group having 5 to 40 aromatic ring atoms, preferably 5 to 25 aromatic ring atoms, more preferably 5 to 18 aromatic ring atoms, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic or heteroaromatic ring system having 5 to 40 aromatic ring atoms, preferably 5 to 25 aromatic ring atoms, more preferably 5 to 18 aromatic ring atoms, an aralkylene group, a heteroaralkylene group, an alkylarylene group or an alkylheteroarylene group, each of which may be substituted by one or more groups R^{a}, and where in each case one or more H atoms may be replaced by D, F, Cl, Br, I, CN, NO₂; or a group represented by the following chemical formula (II) or (II′);

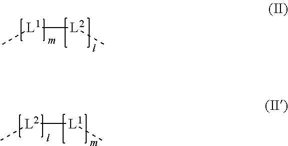

wherein
m is an integer of 1 to 50, preferably 1 to 25, more preferably 2 to 20, and furthermore preferably 4 to 12;
I is 0 or an integer of 1 to 25, preferably 0 or 1 to 20, more preferably 0 or 1 to 12, and furthermore preferably 0 or 1 to 8;
L¹ is

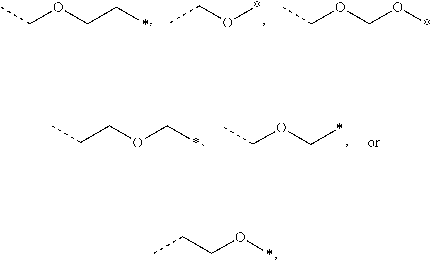

preferably

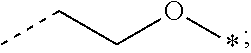

L² is

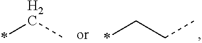

preferably

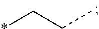

wherein a dashed line indicates a bond to the remainder of the compound and the symbol “*” marks the bond between groups L¹ and L², and wherein each of L¹ and L² may be substituted by one or more groups R^{a}, where one or more CH₂ groups of L¹ and L² may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, NR^{a}, or —C(═O)NR^{a}—, and where one or more H atoms in L¹ and L² may be replaced by D, F, Cl, Br, I, CN or NO₂;
X^{LA1} is, identically or differently on each occurrence, an anchor group preferably selected from —COOM¹, —CO-A³-COOM¹, —OCO-A³-COOM¹, —NCO-A³-COOM¹, —PO(OH)(OM¹), —PO(OM¹)₂, —OC(S)SM¹, —NH₂, —NHR^{a}, —N(R^{a})₂, —SO₃M¹, -SM¹, —Ar¹—SM¹, —OCO-A³-SM¹, —COO-A³-SM¹, —NCO-A³-SM¹, SiOR^{a}, or —N(CS₂M¹)₂;
Ar¹ is a divalent group selected from an aromatic ring system or a heteroaromatic ring system having 5 to 40 aromatic ring atoms, preferably 5 to 25 aromatic ring atoms, more preferably 5 to 18 aromatic ring atoms, each of which may be substituted by one or more groups R^{a}, and where one or more H atoms of the aromatic or heteroaromatic ring system may be replaced by D, F, Cl, Br, I, CN, NO₂;
A³ is a divalent group selected from a straight-chain alkylene group having 1 to 40 carbon atoms, preferably 1 to 25 carbon atoms, more preferably 1 to 15 carbon atoms; a branched or cyclic alkylene group having 3 to 40 carbon atoms, preferably 3 to 25 carbon atoms, more preferably 3 to 15 carbon atoms, each of which may be substituted by one or more groups R^{a}, where in each case one or more CH₂ groups may be replaced by, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic or heteroaromatic ring system having 5 to 25 aromatic ring atoms, preferably 5 to 18 aromatic ring atoms, more preferably 5 to 12 aromatic ring atoms, each of which may be substituted by one or more groups R^{a}, and where one or more H atoms of the aromatic or heteroaromatic ring system may be replaced by D, F, Cl, Br, I, CN, NO₂; preferably A³ is not substituted by R^{a} and/or said one or more H atoms is not replaced;
M¹ denotes a hydrogen atom, or a metal cation selected from ½ Mg²⁺, ½ Cu²⁺, ½ Zn²⁺, ½ Pb²⁺, ½ Sn²⁺, ½ Cd²⁺, ⅓ Bi³⁺ or ¼ Sn⁴⁺, preferably a hydrogen atom, ½ Mg²⁺, ½ Cu²⁺, or ½ Zn²⁺, more preferably a hydrogen atom;

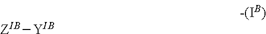

wherein
Z^{IB} is *—R^{x1} or

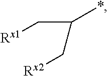

where “*” represents the connecting point to symbol Y of the formula;
R^{x1} is a group selected from one or more members of the group consisting of phosphine group, phosphine oxide group, phosphate group, phosphonate group, thiol group, tertiary amine, carboxyl group, hetero cyclic group, silane group, sulfonic acid, hydroxyl group, phosphonic acid, preferably said group is a phosphonate group, thiol group, a carboxyl group or a combination of any of these, more preferably it is a carboxyl group; and
R^{x2} is a group selected from one or more of members of the group consisting of phosphine group, phosphine oxide group, phosphate group, phosphonate group, thiol group, tertiary amine, carboxyl group, hetero cyclic group, silane group, sulfonic acid, hydroxyl group, phosphonic acid, preferably said group is a phosphonate group, thiol group, a carboxyl group or a combination of any of these, more preferably it is a carboxyl group;
Y^{IB} is a straight-chain alkyl group having carbon atoms 1 to 45 or branched alkyl group having carbon atoms 3 to 45, straight-chain alkenyl group having carbon atoms 1 to 45 or branched alkenyl group having carbon atoms 3 to 45, straight-chain alkoxyl group having carbon atoms 1 to 45 or branched alkoxyl group having carbon atoms 3 to 45, preferably said carbon atoms of the alkyl group, the alkenyl group and/or the alkoxy group are in the range from 10 to 35, more preferably it is from 14 to 30, even more preferably from 16 to 28, furthermore preferably it is from 19 to 26, preferably said alkyl group, alkenyl group and/or alkoxy group may be substituted or unsubstituted, more preferably said alkyl group, alkenyl group and/or alkoxy group, may be substituted by one or more radicals R^{a}, where one or more non-adjacent CH₂ groups may be replaced by R^{a}C═CR^{a}, C≡C, Si(R^{a})₂, Ge(R^{a})₂, Sn(R^{a})₂, C═O, C═S, C═Se, C═NR^{a}, P(═O)(R^{a}), SO, SO₂, NR^{a}, OS, or CONR^{a} and where one or more H atoms may be replaced by D, F, Cl, Br, I, CN or NO₂, preferably Y is a straight-chain or branched alkyl group,
R^{a} is at each occurrence, identically or differently, H, D or an alkyl group having 1 to 20 carbon atoms, cyclic alkyl or alkoxy group having 3 to 40 carbon atoms, an aromatic ring system having 5 to 60 carbon ring atoms, or a hetero aromatic ring system having 5 to 60 carbon atoms, wherein H atoms may be replaced by D, F, Cl, Br, I; two or more adjacent substituents
R^{a} here may also form a mono- or polycyclic, aliphatic, aromatic or heteroaromatic ring system with one another,
wherein Y^{IB} contains at least one carbon-carbon double bond, preferably said chain contains 1 to 5 carbon-carbon double bonds, more preferably 1 to 3 carbon-carbon double bonds, even more preferably 1 to 2 carbon-carbon double bonds in the chain.
2. The composition of embodiment 1, wherein L is selected from a straight-chain alkylene group having 1 to 40 carbon atoms, preferably 3 to 24 carbon atoms, more preferably 4 to 12 carbon atoms; a branched or cyclic alkylene group having 3 to 40 carbon atoms, preferably 4 to 24 carbon atoms, more preferably 5 to 12 carbon atoms; a straight-chain alkenylene or alkynylene group having 2 to 40 carbon atoms, preferably 3 to 24 carbon atoms, more preferably 4 to 12 carbon atoms; or a branched alkenylene group or alkynylene group having 3 to 40 carbon atoms, preferably 4 to 24 carbon atoms, more preferably 5 to 12 carbon atoms, each of which each may be substituted by one or more groups R^{a}, where in each case one or more CH₂ groups may be replaced by an arylene group or heteroarylene group having 5 to 40 aromatic ring atoms, preferably 5 to 25 aromatic ring atoms, more preferably 5 to 18 aromatic ring atoms, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; or a group represented by chemical formula (II) or (II′);

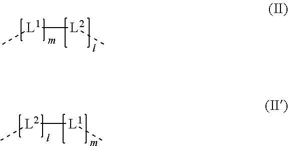

wherein
L¹ is

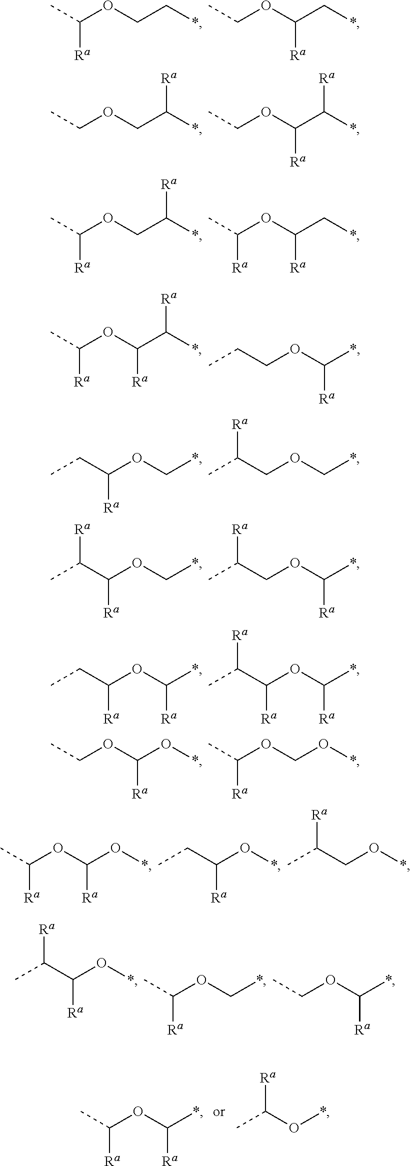

preferably, L¹ is

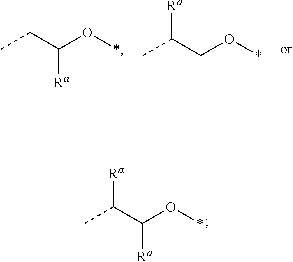

and L² is

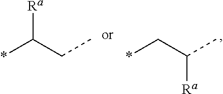

preferably R^{a}
where m, l and R^{a} are as defined in embodiment 1.

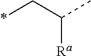

3. The composition of embodiment 1 or 2, wherein the compound of chemical formula (I^{A}) represents a compound of the compound of the following chemical formula (III)

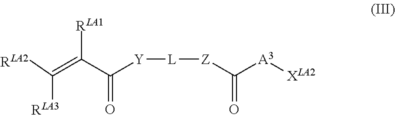

wherein the symbols occurring are as defined in any one of claims 1 to 6, and wherein Z is a direct bond, C, N or O, preferably it is a direct bond, N or O;
X^{LA2} is, —COOM¹ or -SM¹,
More preferably, Z is a direct bond and XLA² is —COOM¹, or Z is N or O and X^{LA2} is -SM¹.
4. The composition of any one of embodiments 1 to 3, wherein the ratio of the total amount of the chemical compound to the total weight of the light emitting moiety is in the range from 0.01 to 10 wt %, preferably it is in the range from 0.1 to 5 wt %, more preferably from 0.5 to 3 wt %; in case of said light emitting moiety is an inorganic light emitting material, the ratio of the weight of the chemical compound to the weight of the inorganic part of the inorganic light luminescent material is in the range from 0.01 to 20 wt %, preferably from 0.2 to 10 wt %, more preferably from 1 to 6 wt %.
5. The composition of any one of embodiments 1 to 4, wherein the reactive monomer is a (meth)acrylate monomer selected from a mono-(meth)acrylate monomer, a di-(meth)acrylate monomer or a tri-(meth)acrylate monomer more preferably it is a di-methacrylate monomer or a di-acrylate monomer, tri-methacrylate monomer, tri-acrylate monomer, even more preferably it is represented by following chemical formula (II);

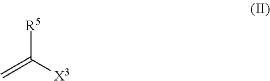

X³ is a non-substituted or substituted alkyl group, aryl group or an alkoxy group;
R⁵ is a hydrogen atom, halogen atom of Cl, Br, or F, methyl group, alkyl group, aryl group, alkoxy group, ester group, or a carboxylic acid group.
preferably the symbol X³ is

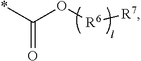

where “*” on the left side of the formula represents the connecting point to the end group C═CR⁵ of the formula (I);
I is 0 or 1;
R⁵ is a hydrogen atom, halogen atom of Cl, Br, or F, methyl group, alkyl group, aryl group, alkoxy group, ester group, or a carboxylic acid group;
R⁶ is a straight alkylene chain or alkoxylene chain having 1 to 25 carbon atoms, preferably R⁶ is a straight alkylene chain or alkoxylene chain having 1 to 15 carbon atoms, more preferably 1 to 5 carbon atoms, which may be substituted by one or more radicals R^{x}, where one or more non-adjacent CH₂ groups may be replaced by R^{x}C═CR^{x}, C≡C, Si(R^{x})₂, Ge(R^{x})₂, Sn(R^{x})₂, C═O, O, C═S, C═Se, C═NR^{x}, P(═O)(R^{x}), SO, SO₂, NR^{x}, OS, oxygen or CONR^{x} and where one or more H atoms may be replaced by D, F, Cl, Br, I, CN or NO₂;
R⁷ is a straight alkyl chain or alkoxylene chain having 1 to 25 carbon atoms, preferably R⁷ is a straight alkylene chain or alkoxylene chain having 1 to 15 carbon atoms, more preferably 1 to 5 carbon atoms,
which may be substituted by one or more radicals R^{x}, where one or more non-adjacent CH₂ groups may be replaced by R^{x}C═CR^{x}, C≡C, Si(R^{x})₂, Ge(R^{x})₂, Sn(R^{x})₂, C═O, O, C═S, C═Se, C═NR^{x}, P(═O)(R^{x}), SO, SO₂, NR^{x}, OS, oxygen or CONR^{x} and where one or more H atoms may be replaced by D, F, Cl, Br, I, CN or NO₂;
R^{x} is at each occurrence, identically or differently, H, D or an alkyl group having 1 to 20 carbon atoms, cyclic alkyl or alkoxy group having 3 to 40 carbon atoms, an aromatic ring system having 5 to 60 carbon ring atoms, or a hetero aromatic ring system having 5 to 60 carbon atoms, wherein H atoms may be replaced by D, F, Cl, Br, I; two or more adjacent substituents R^{x} here may also form a mono- or polycyclic, aliphatic, aromatic or heteroaromatic ring system with one another.
8. The composition of any one of embodiments 1 to 7, further comprises a (meth)acrylate monomer represented by following chemical formula (I) and/or a (meth)acrylate monomer represented by following chemical formula (III);

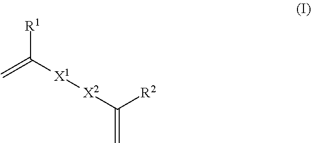

wherein
X¹ is a non-substituted or substituted alkyl group, aryl group or an alkoxy group or an ester group;
X² is a non-substituted or substituted alkyl group, aryl group or an alkoxy group or an ester group;
R¹ is a hydrogen atom, halogen atom of Cl, Br, or F, methyl group, alkyl group, aryl group, alkoxy group, ester group, or a carboxylic acid group;
R² is a hydrogen atom, halogen atom of Cl, Br, or F, methyl group, alkyl group, aryl group, alkoxy group, ester group, or a carboxylic acid group;
preferably the symbol X¹ is

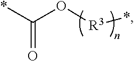

where “*” on the left side of the formula represents the connecting point to the carbon atom of the end group C═CR¹ of the formula (I) and “*” on the right side represents the connecting point to symbol X² of the formula (I); n is 0 or 1;
preferably the symbol X² is

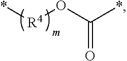

where “*” on the left side of the formula represents the connecting point to symbol X1 of the formula (I) and “*” on the right side represents the connecting point to the end group C═CR² of the formula (I);
m is 0 or 1;
preferably at least m or n is 1;
R³ is a straight or branched alkylene chain or alkoxylene chain having 1 to 25 carbon atoms, a cycloalkane having 3 to 25 carbon atoms or an aryl group having 3 to 25 carbon atoms, preferably R³ is a straight alkylene chain or alkoxylene chain having 1 to 15 carbon atoms, more preferably 1 to 5 carbon atoms,
which may be substituted by one or more radicals R^{x}, where one or more non-adjacent CH₂ groups may be replaced by R^{x}C═CR^{x}, C≡C, Si(R^{x})₂, Ge(R^{x})₂, Sn(R^{x})₂, C═O, O, C═S, C═Se, C═NR^{x}, P(═O)(R^{x}), SO, SO₂, NR^{x}, OS, oxygen or CONR^{x} and where one or more H atoms may be replaced by D, F, Cl, Br, I, CN or NO₂;
R⁴ is a straight or branched alkylene chain or alkoxylene chain having 1 to 25 carbon atoms, a cycloalkane having 3 to 25 carbon atoms or an aryl group having 3 to 25 carbon atoms, preferably R⁴ is a straight alkylene chain or alkoxylene chain having 1 to 15 carbon atoms, more preferably 1 to 5 carbon atoms,
which may be substituted by one or more radicals R^{x}, where one or more non-adjacent CH₂ groups may be replaced by R^{x}C═CR^{x}, C≡C, Si(R^{x})₂, Ge(R^{x})₂, Sn(R^{x})₂, C═O, O, C═S, C═Se, C═NR^{x}, P(═O)(R^{x}), SO, SO₂, NR^{x}, OS, oxygen or CONR^{x} and where one or more H atoms may be replaced by D, F, Cl, Br, I, CN or NO₂;
R^{x} is at each occurrence, identically or differently, H, D or an alkyl group having 1 to 20 carbon atoms, cyclic alkyl or alkoxy group having 3 to 40 carbon atoms, an aromatic ring system having 5 to 60 carbon ring atoms, or a hetero aromatic ring system having 5 to 60 carbon atoms, wherein H atoms may be replaced by D, F, Cl, Br, I; two or more adjacent substituents R^{x} here may also form a mono- or polycyclic, aliphatic, aromatic or heteroaromatic ring system with one another;

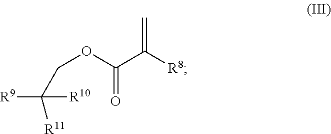

wherein R⁹ is hydrogen atom, a straight alkyl group having 1 to 25 carbon atoms or a (meth)acryl group represented by chemical formula (IV)

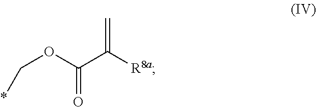

R¹⁰ is hydrogen atom, a straight alkyl group having 1 to 25 carbon atoms or a (meth)acryl group represented by chemical formula (V)

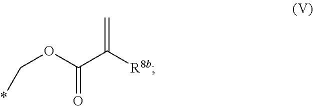

R¹¹ is hydrogen atom, a straight alkyl group having 1 to 25 carbon atoms or a (meth)acryl group represented by chemical formula (VI)

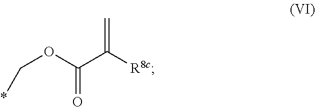

wherein R⁸, R^{8a}, R^{8b} and R^{8c} are, each independently or dependently of each other at each occurrence, H, CH₂CH₃ or CH₃;
wherein at least one of R⁹, R¹⁰ and R¹¹ is a (meth)acryl group, preferably two of R⁹, R¹⁰ and R¹¹ are a (meth)acryl group and other one is a hydrogen atom or a straight alkyl group having 1 to 25 carbon atoms, preferably the electric conductivity (S/cm) of the (meth)acrylate monomer of formula (III) is 1.0*10⁻¹⁰ or less, preferably it is 5.0*10-11 or less, more preferably it is in the range from 5.0*10⁻¹¹ to 1.0*10⁻¹⁵, even more preferably it is in the range from 5.0*10⁻¹² to 1.0*10⁻¹⁵.
9. The composition of any one of embodiments 1 to 8, wherein the (meth)acrylate monomer of chemical formula (II) is in the composition and the mixing ratio of the (meth)acrylate monomer of chemical formula (I) to the (meth)acrylate monomer of chemical formula (II) is in the range from 1:99 to 99:1 (formula (I): formula (II)), preferably from 5:95 to 50:50, more preferably from 10:90 to 40:60, even more preferably it is from 15:85 to 35:65, preferably at least a purified (meth)acrylate monomer represented by chemical formula (I), (II) is used in the composition, more preferably the (meth)acrylate monomer of chemical formula (I) and the (meth)acrylate monomer of chemical formula (II) are both obtained or obtainable by a purification method.
10. The composition of any one of embodiments 1 to 9, wherein the boiling point (B.P.) of said (meth)acrylate monomer of chemical formula (I) and/or chemical formula (II) is 80° C. or more, preferably it is in the range from 80° C. to 400° C., even more preferably from 85° C. to 375° C., further more preferably from 90° C. to 350° C. for large area uniform inkjet printing.
11. The composition of any one of embodiments 1 to 10, wherein said light emitting moiety is an organic light emitting moiety and/or inorganic light emitting moiety, preferably it is an inorganic light emitting moiety, more preferably it is an inorganic light emitting moiety selected from an inorganic phosphor and a quantum material, preferably said light emitting moiety contains a ligand attached onto the outer most surface of the light emitting moiety, more preferably said ligand is the chemical compound of chemical formula (I^{A}); and/or the chemical compound of chemical formula (I^{B}).
12. The composition of any one of embodiments 1 to 11, wherein the total amount of the light emitting moiety is in the range from 0.1 wt. % to 90 wt. % based on the total amount of the composition, preferably from 10 wt. % to 70 wt. %, more preferably from 20 wt. % to 60 wt. %.
13. The composition of any one of embodiments 1 to 12, wherein the viscosity of the composition is 35 cP or less at room temperature, preferably in the range from 1 to 35 cP, more preferably from 2 to 30 cP,
14. The composition of any one of embodiments 1 to 13, comprises another material selected from one or more members of the group consisting of; a (meth)acrylate monomer different from the (meth)acrylate monomer of embodiment 8; scattering particles, transparent polymers, antioxidants, radical quenchers, a photo initiators and surfactants.
15. The composition of any one of embodiments 1 to 14, wherein the composition comprises a solvent 10 wt % or less based on the total amount of the composition, more preferably it is 5 wt % or less, more preferably it is a solvent free composition, preferably the composition does not comprise any one of the following solvent selected from one or more members of the group consisting of ethylene glycol monoalkyl ethers, such as, ethylene glycol monomethyl ether, ethylene glycol monoethyl ether, ethylene glycol monopropyl ether, and ethylene glycol monobutyl ether; diethylene glycol dialkyl ethers, such as, diethylene glycol dimethyl ether, diethylene glycol diethyl ether, diethylene glycol dipropyl ether, and diethylene glycol dibutyl ether; propylene glycol monoalkyl ethers, such as, propylene glycol monomethyl ether(PGME), propylene glycol monoethyl ether, and propylene glycol monopropyl ether; ethylene glycol alkyl ether acetates, such as, methyl cellosolve acetate and ethyl cellosolve acetate; propylene glycol alkyl ether acetates, such as, propylene glycol monomethyl ether acetate (PGMEA), propylene glycol monoethyl ether acetate, and propylene glycol monopropyl ether acetate; ketones, such as, methyl ethyl ketone, acetone, methyl amyl ketone, methyl isobutyl ketone, and cyclohexanone; alcohols, such as, ethanol, propanol, butanol, hexanol, cyclo hexanol, ethylene glycol, triethylene glycol and glycerin; esters, such as, ethyl 3-ethoxypropionate, methyl 3-methoxypropionate and ethyl lactate; and cyclic asters, such as, gamma-butyro-lactone; chlorinated hydrocarbons, such as chloroform, dichloromethane, chlorobenzene, trimethyl benzenes such as 1,3,5-trimethylbenzene, 1,2,4-trimethyl benzene, 1,2,3-trimethyl benzene, docecylbenzene, cyclohexylbenzene, 1,2,3,4-tetramethylbenzene, 1,2,3,5-tetramethylbenzene, 3-isopropylbiphenyl, 3-methylbiphenyl, 4-methylbiphenyl and dichlorobenzene, preferably said solvent is propylene glycol alkyl ether acetates, alkyl acetates, ethylene glycol monoalkyl ethers, propylene glycol, and propylene glycol monoalkyl ethers.
16. The composition of any one of embodiments 1 to 15, comprises at least the (meth)acrylate monomer of chemical formula (III), the (meth)acrylate monomer of chemical formula (II) and the polymer configured so that said polymer enables to the scattering particles to disperse in the composition, wherein the mixing ratio of the (meth)acrylate monomer of chemical formula (III): the (meth)acrylate monomer of chemical formula (II): the polymer is 1:5:0.01:to 5:4:1.
17. Process for fabricating the composition of any one of embodiments 1 to 16 comprising at least the following step Y1 or Y2;
Y1) mixing at least one light emitting moiety, at least one reactive monomer or a mixture of two or more reactive monomers, preferably said monomer having one or more of functional groups, more preferably said monomer is a (meth)acrylate monomer;
a 1^{st} chemical compound represented by the chemical formula (I^{A}); and/or
a 2^{nd} chemical compound represented by the chemical formula (I^{B}) to form the composition.
Y2) mixing at least one light emitting moiety, at least one reactive monomer or a mixture of two or more reactive monomers, preferably said monomer having one or more of functional groups, more preferably said monomer is a (meth)acrylate monomer;
wherein said light emitting nanoparticle has a 1^{st} ligand from the 1^{st} chemical compound represented by the chemical formula (I^{A}); and/or a nd ligand from a 2^{nd} chemical compound represented by the chemical formula (I^{B}).
preferably in step Y1, a 1^{st} chemical compound represented by the chemical formula (I^{A}); and/or
a 2^{nd} chemical compound represented by the chemical formula (I^{B}) to form the composition can be attached as a ligand directly onto the light emitting moiety, preferably in step Y2, a 1^{st} chemical compound represented by the chemical formula (I^{A}); and/or
a 2^{nd} chemical compound represented by the chemical formula (I^{B}) to form the composition can be further added and mixed.
18. The composition obtained or obtainable from the process of embodiment 17.
19. A composite, preferably it is a layered composite, derived or derivable from one or more of the compositions of any one of embodiments 1 to 16, 18.
20. A composite, preferably it is a layered composite, containing at least;
I) a polymer
and
II) a light emitting moiety,
wherein said polymer is derived or derivable from at least one reactive monomer or a mixture of two or more reactive monomers, preferably said monomer having one or more of functional groups, more preferably said monomer is a (meth)acrylate monomer and said polymer;
a 1^{st} chemical compound represented by the chemical formula (I^{A}); and
a 2^{nd} chemical compound represented by the chemical formula (I^{B}).
Preferably at least a part of the surface of the light emitting moiety is connected to the polymer.
21. The composite of embodiment 19 or 20 being a layered composite, has the average layer thickness in the range from 1 to 50 um, preferably 5 to 15, more preferably 8 to 15, furthermore preferably 8-12 um.
22. The composite of any one of the embodiments 19 to 21, is configured to show the EQE value 25% or more, preferably 30% or more and less than 50%.
23. Process of fabricating the composite of any one of embodiments 19 to 22, wherein the process comprises at least the following steps,
I) providing a composition of any one of embodiments 1 to 16 or 18 onto a substrate,
II) curing the composition, preferably said curing is performed by photo irradiation and/or thermal treatment.
24. A composite, preferably a layered composite obtained or obtainable from the process of embodiment 23.
25. Use of the composition of any one of embodiments 1 to 16 or 18, or the composite of any one of embodiments 19 to 22 or 24, in an electronic device, optical device, sensing device or in a biomedical device or for fabricating an electronic device, sensing device, optical device or a biomedical device.
26. A color conversion device (100) comprising at least a pixel, preferably said pixel is a 1^{st} pixel (161) or a 2^{nd} pixel (162), partly or fully filled with the composite of any one of embodiments 19 to 22 or 24, comprising at least a matrix material (120) containing a light emitting moiety (110), and a bank (150) comprising at least a polymer material, preferably the color conversion device (100) further contains a supporting medium (170).
27. The device (100) of embodiment 26, wherein the height of the bank (150) is in the range from 0.1 to 100 μm, preferably it is from 1 to 50 μm, more preferably from 1 to 25 μm, furthermore preferably from 5 to 20 μm.
28. The device (100) of embodiments 26 or 27, wherein the layer thickness of the pixel (161) is in the range from 0.1 to 100 μm, preferably it is from 1 to 50 μm, more preferably from 5 to 25 μm.
29. An optical device (300) containing at least one functional medium (320, 420, 520) configured to modulate a light or configured to emit light, and the composite of any one of embodiments 19 to 22, 24, or the color conversion device (100) of any one of embodiments 26 to 28.

### Technical Effects of the Invention

The present invention provides one or more of following effects, realizing an optimized haze value of the cured layer (film), optimal haze value with improved EQE value of the cured layer (film), preferably obtaining optimal haze value with improved EQE value of the cured layer (film) without using scatting particle, improved thermal stability of an obtained layer (film), improved thermal stability of a light emitting moiety in a layer (film), improved dispersibility of a light emitting moiety in a composition, enabling a phase separation of light emitting moiety and matrix material after curing realizing an improved haze value of the cured film (cured composition), improved dispersibility of a light emitting moiety in an obtained layer, improved long term Quantum Yield (QY) stability of a light emitting moiety in the composition in a longer term storage with our without external light irradiation, improved long term External Quantum Efficiency (EQE) stability of a light emitting moiety in the composition in a longer term storage with our without external light irradiation, improved long term Quantum Yield (QY) stability of a light emitting moiety in the obtained layer (film) in a longer term storage with our without light external irradiation, improved long term External Quantum Efficiency (EQE) stability of a light emitting moiety in the obtained layer (film) in a longer term storage with our without external light irradiation, improved good compatibility of light emitting moiety with a matrix material in a composition and/or an obtained layer (film), and/or realizing easy handling of a composition containing a light emitting moiety and a matrix material, making composition suitable for inkjet printing.

The working examples below provide descriptions of the present invention, as well as an in-detail description of their fabrication. However, the present invention is not necessary to be limited to the working examples.

### WORKING EXAMPLES

LA: lauryl acrylate
HDDA: 1,6-hexanediol diacrylate
HDDMA: hexanediol dimethacrylate
QD: InP based red quantum dot having ZnSe/ZnS double shell layers,
PWL=627 nm, QY=39 nm, QY=92%
QD solution: QDs in heptane supplied as solution
MM: monomer mixture, lauryl acrylate (LA), 1,6-hexanediol diacrylate
(HDDA) ratio 8:2
LG: Ligand, Erucic acid
AO: Antioxidant, Irganox 1010
PI: Photo initiator, Irgacure 819
HM: Haze moderator=Compound L1

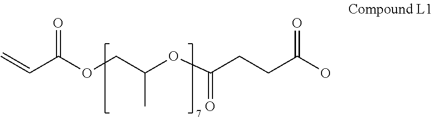

### Preparation Example 1: Preparation of Chemical Compound L1

### Reactants:

| Name | CAS | Vendor | Cat No. | Purity |
|---|---|---|---|---|
| Poly(propylenglycol)acrylate | 50858-51-0 | Sigma- | 469815-100ML | Contains 200-400 ppm |
| | | Aldrich | | monomethyl |
| | | | | ether |
| | | | | hydroquinone |
| | | | | as inhibitor |
| BHT-2,6-Di-tert-butyl-4- | 128-37-0 | Sigma- | B1378-100G | ≥99% |
| methylphenol | | Aldrich | | |
| succinic anhydride | 108-30-5 | ACROS | 250 GR | 99% |
| | | ORGANICS | | |
| DMAP-4-(Dimethylamino)pyridine | 1122-58-3 | Sigma- | 107700-25G | ≥99% |
| | | Aldrich | | |
| anhydrous toluene | 108-88-3 | Sigma- | 244511-1L | 99.8% |
| | | Aldrich | | |

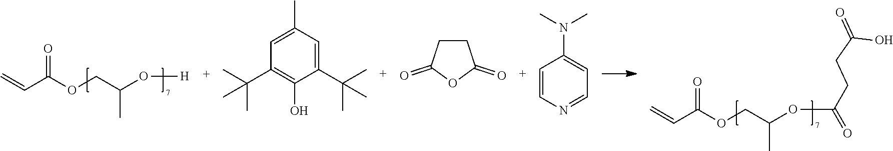

In absence of light, into 1 L 3-neck round bottom flask equipped with stir bar, within soft heating mantle and thermocouple, chiller (5° C.) circulation, under Ar: Poly(propylenglycol)acrylate (10.20 gr), BHT (46 mg), succinic anhydride (2.56 gr) and DMAP (0.13 gr) in anhydrous toluene (520 mL) are stirred together. Reaction heated to reflux (111° C.) overnight under argon.

On the next day, the mixture is cooled down to RT, and extracted with distilled water, then with brine. Organic phase is dried over MgSO₄, filtered via filter paper, then volatiles is removed under reduced pressure on Rotavap.

The residue is purified using silica gel (200-425 mesh) chromatography with CHCl₃ followed by CHCl₃/CH₃OH (97/3). Fractions are collected, volatiles removed. Each fraction is analyzed by 1H NMR and DOSY. Then compound L1 is obtained.
Appearance: Transparent colorless liquid
Sample storage: keep under ambient atmosphere at 4° C.

### Preparation Example 2: Preparation of Derivatives of the Chemical Compound L1

Derivatives of L1 having repeating unit 3-5 instead of 7 repeating unit of L1 (a shorter analogues with 3-5 repeating units compared to L1) are successfully synthesized in the same manner as described in preparation example 1.

Another derivatives to L1 can also be synthesized by changing the reactants, amounts of the reactants with general knowledge based on the synthesis process described in preparation example 1 mentioned above, for examples, alcohols comprising (meth)acrylate group, branched or linear alkoxylene group, branched or linear saturated alkylene group, branched or linear unsaturated alkylene group and be used, any derivative of succinic anhydrate can be used.

### Reference Example 1: Preparation of Matrix

To 0.04 g of Phenylbis(2,4,6-trimethylbenzoyl)phosphine oxide (Irganox(™)819) as photo initiator is added 2.368 g of LA and 0.592 g of HDDA. The mixture is shaken until complete dissolution of Irganox(™)819.

### Reference Example 2: Preparation of Matrix

To 0.04 g of Irganox(™)819 is added 1.580 g of LA and 0.380 g of HDDMA. The mixture is shaken until complete dissolution of Irganox(™)819.

### Reference Example 3: Preparation of Red QD Ink with Compound L1

0.06 g of compound L1 is dissolved in 1 mL of toluene, then mixed with 0.25 g of InP based Red QDs having ZnSe/ZnS double shell layers dispersed in heptane and heated to 40 deg. C. for 1 hour. Then 0.63 g of matrix obtained in example 1 is added, volatiles are evaporated on rotary evaporator under vacuum. Remaining volatiles are removed under vacuum of 60 mTorr on a Schlenk line. Then 0.06 g of TiO₂ dispersed in octane is added. Volatiles are removed under vacuum of 60 mTorr on a Schlenk line. Finally, the QD ink composition 2 is obtained.

### Reference Example 4: Ligand Exchange of Red QD Ink with Compound L1 (Compound L1/QD_{inorg}. Weight Ratio=0.53)

1.17 g of InP based Red QDs having ZnSe/ZnS double shell layers dispersed in 5.1 mL of heptane are put in a glass flask, 5 mL of anhydrous toluene are added, 0.503 g of compound L1 are added, the mixture is flashed with Ar and heated to 40 deg. C. for 1 hour under Ar. After cooling down the solution, the red QDs are precipitated out by adding 96 ml of dry heptane. Then the turbid solution is centrifuged at 2950G for 5 min, and supernatant is decanted. Then 10 mL of dry toluene are added to prepare stock solution in toluene.

Ink Preparation 1 (QD Ink with LG):

LG is added to a 250 ml flask. QD solution is added and the mixture is allowed to homogenize for 2 hours at 40° C. under a constant nitrogen flow. Subsequently, the MM, AO, and PI are added and stirred for 10 min to allow all compounds to dissolve. Finally, heptane/isopropanol is removed using a rotary evaporator (50° C. for 1.5 hours after the pressure reaches <10 mbar).

Ink Preparation 2 (QD Ink with HM):

HM is added to a 250 ml flask and dissolved in isopropanol (1:1 ratio to QD solution). QD solution is added and the mixture is allowed to homogenize for 2 hours at 40° C. under a constant nitrogen flow. Subsequently, the MM, AO, and PI are added and stirred for 10 min to allow all compounds to dissolve. Finally, heptane is removed using a rotary evaporator (50° C. for 1.5 hours after the pressure reaches <10 mbar).

### Comparative Example 1

QD ink 1 (comparative) is prepared so that the ink is comprised of 40 wt % red QDs, 4.8 wt % LG, 1 wt % PI, 0.5 wt % AO, and MM by using ink preparation method 1 indicated above.

### Working Examples 1 to 3

QD inks 2 to 4 (W.E.1 to W.E.3) comprising of 40 wt % red QDs, 1 wt % PI, 1 wt % AO, and MM, and LG and HM as indicated in the following table 1, are prepared by using Ink preparation 1 and 2 both indicated above.

### Working Example 4: Fabrication of 10 um-Thick Films with Using the QD Inks

Film A with 10 um thickness is fabricated using the QD ink 1 (comparative) obtained in comparative example 1 by filling glass sandwich test cell (consisting of two 0.7 mm AF glass substrates separated by 10 micrometer polymer spacers and jointed by an adhesive frame) with the QD ink composition 1. Then QD ink composition inside the glass cell is cured by irradiating light at 395 nm, 300 W/cm² for 10 sec.

In the same manner as described above, Films B, C, D are fabricated with using the QD inks 2 (W.E.1) to 4 (W.E.3) instead of the QD ink 1 (comparative).

### Working Example 5: EQE Measurement

EQE measurement of the films A to F is conducted by using an integrating sphere equipped with excitation light by optical fiber (CWL: 450 nm) and spectrometer ( ). To detect the photons of the excitation light, air is used as a reference at room temperature.

The number of photons of light emission from the test cell towards the integrating sphere is counted by the spectrometer at room temperature.
EQE is calculated by the following calculation method.
EQE=Photons [Emission light]/Photons [Excitation light measured without sample in place]

### Wavelength Range for Calculation

Excitation: 430 nm-470 nm
Emission: [Red QD]580-780 nm

Following table 1 show the results of the measurements.

TABLE 1
Optical properties of 10 um-thick films.
EQE integration range 490-780 nm.

| | LG | HM | | EQE |
|---|---|---|---|---|
| Sample | (wt %) | (wt %) | HM/(LG + HM) | (%) |
| QD ink 1 | 4.8 | 0 | 0 | 32 |
| (Comparative)/Film A | | | | |
| QD ink 2 | 4.13 | 1.54 | 0.27 | 36 |
| (W.E. 1)/Film B | | | | |
| QD ink 3 | 3.85 | 2.16 | 0.36 | 35 |
| (W.E. 2)/Film C | | | | |
| QD ink 4 | 3.2 | 3.59 | 0.53 | 29 |
| (W.E. 3)/Film D | | | | |

1.-15. (canceled)

16. A composition, comprising:
i) at least one reactive monomer or a mixture of two or more reactive monomers;
ii) a light emitting moiety;
iii) a 1^{st} chemical compound represented by following chemical formula (I^{A}); and
iv) a 2^{nd} chemical compound represented by following chemical formula (I^{B}) 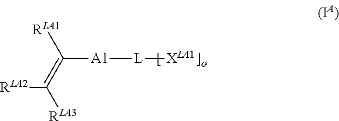
wherein
o is 1, 2 or 3, preferably 1;
R^{LA1} is H, D, CN, a straight chain alkyl or alkoxy group having 1 to 40 carbon atoms; a branched or cyclic alkyl or alkoxy group having 3 to 40 carbon atoms, s, each of which may be substituted by one or more groups R^{a}, where in each case one or more CH₂ groups may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; an aromatic ring system or a heteroaromatic ring system having 5 to 40 aromatic ring atoms, each of which may be substituted by one or more groups R^{a}, and where one or more H atoms may be replaced by D, F, Cl, Br, I, CN or NO₂;
R^{LA2}, R^{LA3} are, independently of each other, H, D, CN, a straight chain alkyl or alkoxy group having 1 to 40 carbon atoms; a branched or cyclic alkyl or alkoxy group having 3 to 40 carbon atoms, each of which may be substituted by one or more groups R^{a}, where in each case one or more CH₂ groups may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; or an aromatic ring system or a heteroaromatic ring system having 5 to 40 aromatic ring atoms, each of which may be substituted by one or more groups R^{a}, and where one or more H atoms may be replaced by D, F, Cl, Br, I, CN or NO₂;
R^{a} is at each occurrence, identically or differently, H, D, a straight chain alkyl or alkoxy group having 1 to 40 carbon atoms; a branched or cyclic alkyl or alkoxy group having 3 to 40 carbon atoms; a straight-chain alkenyl or alkynyl group having 2 to 40 carbon atoms; a branched alkenyl group or alkynyl group having 3 to 40 carbon atoms; an aromatic or heteroaromatic ring system having 5 to 40 aromatic ring atoms, wherein in each of the above-mentioned groups one or more H atoms may be replaced by D, F, Cl, Br, I, and where two or more adjacent substituents R^{a} here may optionally form a mono- or polycyclic, aliphatic ring system with one another;
A¹ is 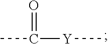
Y is O, N, S;
L is a divalent group selected from a straight-chain alkylene group having 1 to 40 carbon atoms; a branched or cyclic alkylene group having 3 to 40 carbon atoms; a straight-chain alkenylene or alkynylene group having 2 to 40 carbon atoms; or a branched alkenylene group or alkynylene group having 3 to 40 carbon atoms, each of which each may be substituted by one or more groups R^{a}, where in each case one or more CH₂ groups may be replaced by an arylene group or heteroarylene group having 5 to 40 aromatic ring atoms, Si(R^{a})₂, Ge(R^{a})₂, Sn(R^{a})₂, C═O, C═S, C═Se, C═NR^{a}, P(═O)(R^{a}), SO, So₂, —O—, NR^{a}, —C(═O)O—, or —C(═O)NR^{a}—, and where one or more H atoms may be replaced by D, F, Cl, Br, I, CN or NO₂; an aromatic or heteroaromatic ring system having 5 to 40 aromatic ring atoms, an aralkylene group, a heteroaralkylene group, an alkylarylene group or an alkylheteroarylene group, each of which may be substituted by one or more groups R^{a}, and where in each case one or more H atoms may be replaced by D, F, Cl, Br, I, CN, NO₂; or a group represented by the following chemical formula (II) or (II′); 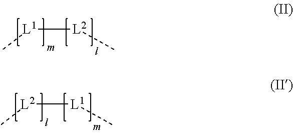
wherein
m is an integer of 1 to 50;
1 is 0 or an integer of 1 to 25;
L¹ is 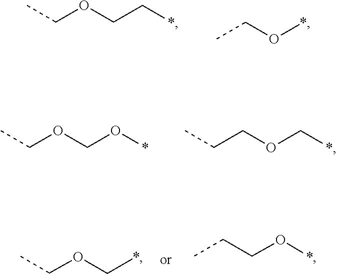
wherein a dashed line indicates a bond to the remainder of the compound and the symbol “*” marks the bond between groups L¹ and L², and wherein each of L¹ and L² may be substituted by one or more groups R^{a}, where one or more CH₂ groups of L¹ and L² may be replaced by —R^{a}C═CR^{a}—, —C≡C—, Si(R^{a})₂, Ge(R^{a})₂, Sn(R^{a})₂, C═O, C═S, C═Se, C═NR^{a}, P(═O)(R^{a}), SO, SO₂, NR^{a}, or —C(═O)NR^{a}—, and where one or more H atoms in L¹ and L² may be replaced by D, F, Cl, Br, I, CN or NO₂;
X^{LA1} is, identically or differently on each occurrence, an anchor group preferably selected from —COOM¹, —CO-A³-COOM¹, —OCO-A³-COOM¹, —NCO-A³-COOM¹, —PO(OH)(OM¹), —PO(OM¹)₂, —OC(S)SM¹, —NH₂, —NHR^{a}, —N(R^{a})₂, —SO_{3M}¹, -SM¹, —Ar¹—SM¹, —OCO-A³-SM¹, —COO-A³-SM¹, —NCO-A³-SM¹, SiOR^{a}, or —N(CS₂M¹)₂;
Ar¹ is a divalent group selected from an aromatic ring system or a heteroaromatic ring system having 5 to 40 aromatic ring atoms, each of which may be substituted by one or more groups R^{a}, and where one or more H atoms of the aromatic or heteroaromatic ring system may be replaced by D, F, Cl, Br, I, CN, NO₂;
A³ is a divalent group selected from a straight-chain alkylene group having 1 to 40 carbon atoms; a branched or cyclic alkylene group having 3 to 40 carbon atoms, each of which may be substituted by one or more groups R^{a}, where in each case one or more CH₂ groups may be replaced by, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂;
an aromatic or heteroaromatic ring system having 5 to 25 aromatic ring atoms, each of which may be substituted by one or more groups R^{a}, and where one or more H atoms of the aromatic or heteroaromatic ring system may be replaced by D, F, Cl, Br, I, CN, NO₂;
M¹ denotes a hydrogen atom, or a metal cation selected from ½ Mg²⁺, ½ Cu²⁺, ½ Zn²⁺, ½ Pb²⁺, ½ Sn²⁺, ½ Cd²⁺, ⅓ Bi³⁺ or ¼ Sn⁴⁺: 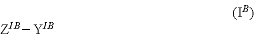
wherein
Z^{IB} is *—R^{x1} or 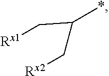
where “*” represents the connecting point to symbol Y of the formula;
R^{x1} is a group selected from one or more members of the group consisting of phosphine group, phosphine oxide group, phosphate group, phosphonate group, thiol group, tertiary amine, carboxyl group, hetero cyclic group, silane group, sulfonic acid, hydroxyl group, phosphonic acid; and
R^{x2} is a group selected from one or more of members of the group consisting of phosphine group, phosphine oxide group, phosphate group, phosphonate group, thiol group, tertiary amine, carboxyl group, hetero cyclic group, silane group, sulfonic acid, hydroxyl group, phosphonic acid;
Y^{IB} is a straight-chain alkyl group having carbon atoms 1 to 45 or branched alkyl group having carbon atoms 3 to 45, straight-chain alkenyl group having carbon atoms 1 to 45 or branched alkenyl group having carbon atoms 3 to 45, straight-chain alkoxyl group having carbon atoms 1 to 45 or branched alkoxyl group having carbon atoms 3 to 45, may be substituted by one or more radicals R^{a}, where one or more non-adjacent CH₂ groups may be replaced by R^{a}C═CR^{a}, C≡C, Si(R^{a})₂, Ge(R^{a})₂, Sn(R^{a})₂, C═O, C═S, C═Se, C═NR^{a}, P(═O)(R^{a}), SO, SO₂, NR^{a}, OS, or CONR^{a} and where one or more H atoms may be replaced by D, F, Cl, Br, I, CN or NO₂,
R^{a} is at each occurrence, identically or differently, H, D or an alkyl group having 1 to 20 carbon atoms, cyclic alkyl or alkoxy group having 3 to 40 carbon atoms, an aromatic ring system having 5 to 60 carbon ring atoms, or a hetero aromatic ring system having 5 to 60 carbon atoms, wherein H atoms may be replaced by D, F, Cl, Br, I; two or more adjacent substituents R^{a} here may also form a mono- or polycyclic, aliphatic, aromatic or heteroaromatic ring system with one another,
wherein Y^{IB} contains at least one carbon-carbon double bond.

17. The composition of claim 16, wherein L is selected from a straight-chain alkylene group having 1 to 40 carbon atoms; a branched or cyclic alkylene group having 3 to 40 carbon atoms; a straight-chain alkenylene or alkynylene group having 2 to 40 carbon atoms; or a branched alkenylene group or alkynylene group having 3 to 40 carbon atoms, each of which each may be substituted by one or more groups R^{a}, where in each case one or more CH₂ groups may be replaced by an arylene group or heteroarylene group having 5 to 40 aromatic ring atoms, Si(R^{a})₂, Ge(R^{a})₂, Sn(R^{a})₂, C═O, C═S, C═Se, C═NR^{a}, P(═O)(R^{a}), SO, SO₂, —O—, NR^{a}, —C(═O)O—, or —C(═O)NR^{a}—, and where one or more H atoms may be replaced by D, F, Cl, Br, I, CN or NO₂; or a group represented by chemical formula (II) or (II′); 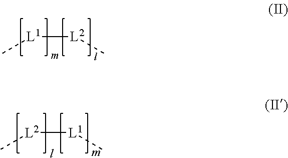
wherein
L¹ is 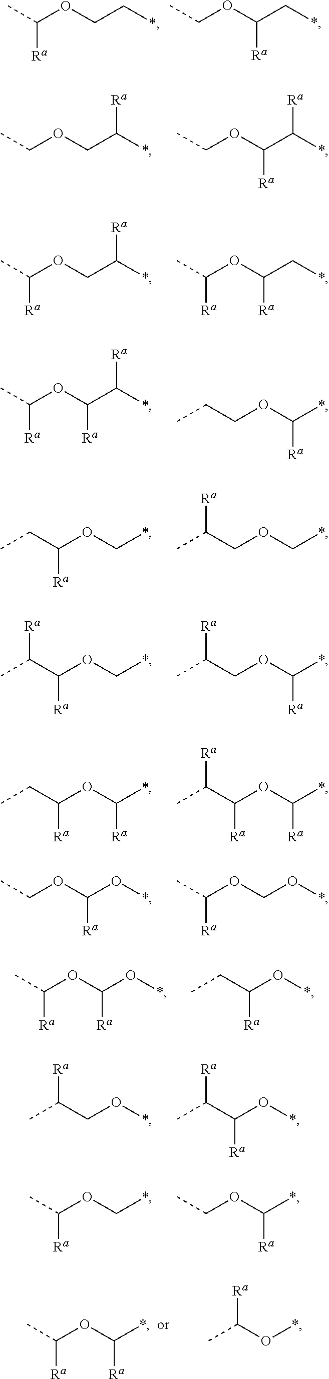
where m, l and R^{a} are as defined in claim 16.

18. The composition of claim 16, wherein the compound of chemical formula (I^{A}) is a compound of the following chemical formula (III); 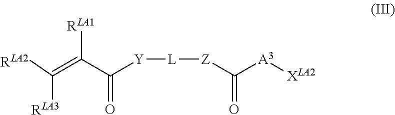
wherein the symbols occurring are as defined in claim 16, and wherein Z is a direct bond, C, N or O, preferably it is a direct bond, N or O;
X^{LA2} is, —COOM¹ or -SM¹,
more preferably, Z is a direct bond and X^{LA2} is —COOM¹ or Z is N or O and X^{LA2} is -SM¹.

19. The composition of claim 16, wherein the ratio of the total amount of the chemical compound to the total weight of the light emitting moiety is in the range from 0.01 to 10 wt %; in case of said light emitting moiety is an inorganic light emitting material, the ratio of the weight of the chemical compound to the weight of the inorganic part of the inorganic light luminescent material is in the range from 0.01 to 20 wt %.

20. The composition of claim 16, wherein the reactive monomer is a (meth)acrylate monomer selected from a mono-(meth)acrylate monomer, a di-(meth)acrylate monomer or a tri-(meth)acrylate monomer;
X³ is a non-substituted or substituted alkyl group, aryl group or an alkoxy group;
R⁵ is a hydrogen atom, halogen atom of Cl, Br, or F, methyl group, alkyl group, aryl group, alkoxy group, ester group, or a carboxylic acid group.

21. The composition of claim 16, further comprises a (meth)acrylate monomer represented by following chemical formula (I) and/or a (meth)acrylate monomer represented by following chemical formula (III);
wherein 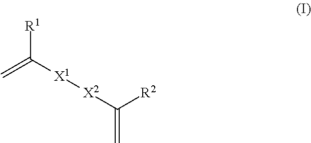
X¹ is a non-substituted or substituted alkyl group, aryl group or an alkoxy group or an ester group;
X² is a non-substituted or substituted alkyl group, aryl group or an alkoxy group or an ester group;
R¹ is a hydrogen atom, halogen atom of Cl, Br, or F, methyl group, alkyl group, aryl group, alkoxy group, ester group, or a carboxylic acid group;
R² is a hydrogen atom, halogen atom of Cl, Br, or F, methyl group, alkyl group, aryl group, alkoxy group, ester group, or a carboxylic acid group; 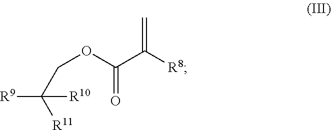
wherein
R⁹ is hydrogen atom, a straight alkyl group having 1 to 25 carbon atoms or a (meth)acryl group represented by chemical formula (IV) 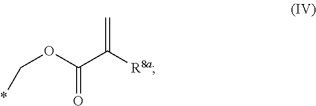
R¹⁰ is hydrogen atom, a straight alkyl group having 1 to 25 carbon atoms or a (meth)acryl group represented by chemical formula (V) 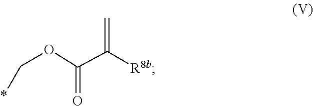
R¹¹ is hydrogen atom, a straight alkyl group having 1 to 25 carbon atoms or a (meth)acryl group represented by chemical formula (VI) 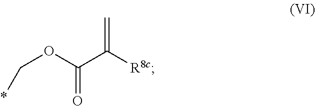
wherein R⁸, R^{8a}, R^{8b} and R^{8c} are, each independently or dependently of each other at each occurrence, H, CH₂CH₃ or CH₃;
wherein at least one of R⁹, R¹⁰ and R¹¹ is a (meth)acryl group.

22. The composition of claim 16, wherein the total amount of the light emitting moiety is in the range from 0.1 wt. % to 90 wt. % based on the total amount of the composition.

23. The composition of claim 16, comprises another material selected from one or more members of the group consisting of a further (meth)acrylate monomer; scattering particles, transparent polymers, antioxidants, radical quenchers, a photo initiators and surfactants.

24. The composition of claim 16, wherein the composition comprises a solvent 10 wt % or less based on the total amount of the composition.

25. A process for preparing the composition of claim 16,
comprising at least the following step Y1 or Y2;
Y1) mixing at least one light emitting moiety, at least one reactive monomer or a mixture of two or more reactive monomers, preferably said monomer having one or more of functional groups;
a 1^{st} chemical compound represented by chemical formula (I^{A}); and/or
a 2^{nd} chemical compound represented by chemical formula (I^{B}) to form the composition.
Y2) mixing at least one light emitting moiety, at least one reactive monomer or a mixture of two or more reactive monomers;
wherein said light emitting nanoparticle has a 1st ligand from the 1st chemical compound represented by chemical formula (I^{A}); and/or a 2^{nd} ligand from a 2^{nd} chemical compound represented by chemical formula (I^{B}).

26. A composite derived from one or more of the compositions of claim 16.

27. A composite containing at least;
I) a polymer
and
II) a light emitting moiety,
wherein said polymer is derived or derivable from at least one reactive monomer or a mixture of two or more reactive monomers, preferably said monomer having one or more of functional groups, more preferably said monomer is a (meth)acrylate monomer and said polymer;
a 1^{st} chemical compound represented by chemical formula (I^{A}); and
a 2^{nd} chemical compound represented by chemical formula (I^{B}) Preferably at least a part of the surface of the light emitting moiety is connected to the polymer.

28. The process for preparing the composite of claim 26, wherein the process comprises at least the following steps;
I) providing the composition and applying the composition onto a substrate,
II) curing the composition, preferably said curing is performed by photo irradiation and/or thermal treatment.

29. A color conversion device comprising at least a pixel partly or fully filled with the composite of claim 26 comprising at least a matrix material containing a light emitting moiety, and a bank comprising at least a polymer material.

30. An optical device (300) containing at least one functional medium (320, 420, 520) configured to modulate a light or configured to emit light; and the composite of claim 26.
